(19) United States
(12) Patent Application Publication
(10) Pub. No.: US 2024/0216225 A1
(43) Pub. Date: Jul. 4, 2024

(54) FORMULATION CARTRIDGE ASSEMBLY AND FORMULATION DISPENSER HAVING THE SAME

(71) Applicant: ALGOCARE CORPORATION, Seoul (KR)

(72) Inventors: Jiwon JOUNG, Seoul (KR); Pil Lip YOUN, Seoul (KR)

(73) Assignee: ALGOCARE CORPORATION, Seoul (KR)

(21) Appl. No.: 18/555,182

(22) PCT Filed: Nov. 11, 2022
(86) PCT No.: PCT/KR2022/017787

§ 371 Date: Oct. 12, 2023

(30) Foreign Application Priority Data
Nov. 19, 2021 (KR) 10-2021-0160228
Dec. 30, 2021 (KR) 10-2021-0193553

(51) Int. Cl. A61J 7/00; A61J 1/06; A61J 1/16

(52) U.S. Cl. CPC A61J 7/0076; A61J 1/065; A61J 1/16

(57) ABSTRACT

The present disclosure relates to a formulation cartridge assembly including a housing in which a formulation is disposed in an inner space thereof, a discharge cap coupled and fixed to the housing and provided with a rotor insertion hole of which a central portion is opened and a discharge hole, through which the formulation is discharged, in a portion of an edge thereof, and a rotor of which a portion is inserted into the rotor insertion hole so as to be rotatably coupled using the rotor insertion hole as a center, the rotor including a formulation guide hole in which the formulation to be discharged to the discharge hole is seated.

### TECHNICAL FIELD

The present invention relates to a formulation cartridge assembly and a formulation dispenser having the same.

### BACKGROUND ART

Nutritional supplements containing trace elements (zinc, iron, magnesium, etc.) or vitamins are generally recognized as health supplements supplemented by the human body.

However, these nutritional supplements are sometimes used as therapeutic agents if necessary, and when used as the therapeutic agents, the dosage may be strictly limited depending on the patient's condition.

For example, the patient with osteomalacia has to receive and take vitamin D, and the dosage is determined according to a calcium concentration in the blood. If the patient takes an excessive amount of vitamin D, side effects such as calcium stones or hypertensive disease may occur.

In addition, isoniazid used for tuberculosis treatment may rapidly consume niacin (nicotinic acid) contained in the patient's blood during the tuberculosis treatment.

Thus, when niacin deficiency occurs, the physician determines the appropriate dosage of isoniazid for the patient according to the concentration of niacin in the patient's blood.

As described above, there is a risk that the nutritional supplements taken for health may act as poisons that harm health depending on the physical condition of each user, such as whether or not there is an underlying disease, and thus, it is important to take a necessary amount for the body.

There is a case in which the patent needs to take medicine for the rest of your life depending on the type of disease such as hypertensive patients, diabetic patients, and hypothyroidism patients, and in this case, it is often necessary to adjust the dosage of the drug according to the patient's physical condition.

However, many of the drugs used by patients are pills with a fixed dose, such as 50 mg or 100 mg, which causes doctors to prescribe step-by-step doses of drugs instead of prescribing the exact dose appropriate for the patient's condition.

For example, if the symptoms of a hypertensive patient who was prescribed a 50 mg dose of the drug worsen, the doctor will prescribe the next commercially available dose of 100 mg of the drug to the patient instead of increasing in dose according to the degree of worsening.

As described above, it is good to take formulation such as nutritional supplements or pills taken for health supplements or treatment purposes at a specified time according to the user's physical condition.

However, it is difficult to take the type of formulation that is exactly right for oneself. Particularly, when taking a formulation as a health supplement, such as the nutritional supplement, unlike in the case of a disease, it is very difficult to take the formulation consistently in an accurate manner because it does not directly affect the current body health.

### DISCLOSURE OF THE INVENTION

### Technical Problem

An object of the present invention for solving the problem is to improve convenience of a user by conveniently taking formulation.

Another object of the present invention for solving the problem is to enable rapid discharge without damaging formulation.

### Technical Solution

A formulation cartridge assembly according to an embodiment of the present invention include a housing in which formulation is disposed in an inner space thereof, a discharge cap coupled and fixed to the housing and provided with a rotor insertion hole of which a central portion is opened and a discharge hole, through which the formulation is discharged, in a portion of an edge thereof, and a rotor of which a portion is inserted into the rotor insertion hole so as to be rotatably coupled using the rotor insertion hole as a center, the rotor including a formulation guide hole in which the formulation to be discharged to the discharge hole is seated, wherein the formulation guide hole extends outward from the inside of the rotor and has a width and length, which are defined by seating and arranging a plurality of formulations comprising a first formulation and a second formulation in a line in the formulation guide hole, and as the rotor rotates, the plurality of formulations arranged in the formulation guide hole are sequentially discharged through the discharge hole.

The housing may include: a housing body configured to define an outer appearance of the housing and extend in a vertical direction; an insertion restriction part disposed to be spaced apart from the housing body inside the housing body and extending in the vertical direction; a connection part extending from a lower end of the insertion restriction part and connected to the housing body; and a formulation guide protrusion which is provided to protrude downward from the connection part and of which a portion overlaps the discharge hole, wherein, when the housing body is viewed from the top, an outer portion of the rotor is covered by the insertion restriction part.

The formulation guide protrusion may increase in protruding length and cross-sectional width as the formulation guide protrusion approaches the discharge hole.

A lower end of the formulation guide protrusion may include a first portion of which a protruding length is constantly maintained and a second portion of which a protruding length gradually increases toward the discharge hole, wherein the first portion may be disposed closer to the discharge hole than the second portion and vertically overlaps the discharge hole.

The discharge cap may further include: a rotor insertion hole of which a central portion is opened; a flat first guide surface configured to surround the rotor insertion hole; and a second guide surface connected to the first guide surface so as to surround the first guide surface, the second guide surface being inclined toward the outside.

The discharge hole may be disposed in a portion of an edge of the discharge cap and disposed on an extension line of the second guide surface.

An interval between a lower end of a portion of the formulation guide protrusion, which overlaps the discharge hole, and the first guide surface may be less than a width or height of the formulation.

The insertion restriction part may be adjacent to a boundary surface between the first guide surface and the second guide surface in the vertical direction.

The second guide surface may include a first inclined portion that is inclined toward the outside of the second guide surface and a second inclined portion that is inclined toward the discharge hole, wherein one end of the second inclined portion may be disposed to be in contact with the discharge hole, and the other end of the second inclined portion may be disposed to be in contact with the first inclined portion.

The second inclined portion of the second guide surface and the portion of which the protruding length increases from the formulation guide protrusion may overlap each other in the vertical direction and be inclined to correspond to each other.

A bottom surface of the connection part may be inclined toward the outside, and the first inclined portion of the second guide surface and the bottom surface of the connection part may overlap each other in the vertical direction and are inclined to correspond to each other.

The rotor may include: a rotor cone; a first rotor rail connected to the rotor cone, disposed along the outside of the rotor cone, and disposed to overlap the first guide surface; a second rotor rail connected to the first rotor rail, disposed along the outside of the first rotor rail, and disposed to overlap the second guide surface; and a driving shaft part disposed at a lower portion of the rotor cone and inserted into the rotor insertion hole, wherein each of the first rotor rail and the second rotor rail may be divided into a plurality of portions by the formulation guide hole.

A stepped portion may be provided between the first rotor rail and the second rotor rail, and a top surface of the second rotor rail may be disposed to be spaced downward from a top surface of the first rotor rail.

The insertion restriction part may be disposed adjacent to a boundary line between the first rotor rail and the second rotor rail, wherein an interval between a lower end of the insertion restriction part and a top surface of the first rotor rail may be less than a width or height of the formulation.

The formulation guide protrusion may be adjacent to the discharge hole and disposed outside the first rotor rail, wherein a lower end of a portion of the formulation guide protrusion may be disposed lower than a top surface of the first rotor rail.

The formulation cartridge assembly may further include a cartridge configured to accommodate the formulation therein and coupled to the housing so that the formulation is introduced into the inner space of the housing.

A dispenser according to an embodiment of the present invention includes a plurality of formulation cartridge assemblies, a plurality of motors connected to driving shaft parts of the plurality of formulation cartridge assemblies, respectively, and a driving control part configured to control each of the plurality of motors.

The formulation cartridge assembly may further include a discharge number detection part configured to detect the number of formulations discharged through the discharge hole of each of the plurality of formulation cartridge assemblies, wherein the discharge number detection part may be disposed below the discharge hole of each of the plurality of formulation cartridge assemblies and connected to the driving control part.

### Advantageous Effects

According to these features, the present invention may automatically discharge the corresponding formulation according to the type and dosage of the formulation to be taken according to the current user's physical condition, and thus, the user's convenience may be greatly improved.

### BRIEF DESCRIPTION OF THE DRAWINGS

FIGS. 1a to 1c are view for explaining a formulation dispenser according to an embodiment of the present invention.

FIG. 2 is a cross-sectional view of the formulation dispenser illustrated in FIG. 1a.

FIG. 3 is a perspective view illustrating a formulation cartridge assembly of the formulation dispenser according to an embodiment of the present invention.

FIG. 4 is an exploded perspective view of the formulation cartridge assembly illustrated in FIG. 3.

FIG. 5 is a view when a discharge unit illustrated in FIG. 4 is viewed from the top.

FIGS. 6a to 6d are views illustrating a housing of the formulation cartridge assembly illustrated in FIG. 3.

FIG. 7 is a view for explaining an example of a portion at which the housing and a cartridge are coupled to each other in the formulation dispenser according to an embodiment of the present invention.

FIG. 8 is a view for explaining an example of a discharge cap in the formulation cartridge assembly illustrated in FIG. 3.

FIGS. 9a to 9d are views for explaining an example of a rotor in the formulation cartridge assembly illustrated in FIG. 3.

FIGS. 10a to 10d are views for explaining a state in which the rotor is coupled to the discharge cap in the formulation cartridge assembly illustrated in FIG. 3.

FIGS. 11a to 11c are views for explaining a coupling relationship between the housing and the discharge cap in the formulation cartridge assembly illustrated in FIG. 3.

FIGS. 12a to 12d are views for explaining a coupling relationship between the housing, the rotor, and the discharge cap.

FIGS. 13 to 17 are views for explaining a process of discharging formulation through the discharge unit according to an embodiment of the present invention.

FIG. 18 is a schematic block diagram illustrating a control unit of the formulation dispenser according to an embodiment of the present invention.

FIGS. 19a and 19b are operation flowcharts related to a formulation discharge operation in a cartridge control unit of the formulation dispenser according to an embodiment of the present invention.

FIG. 20 is a view for explaining another example of the discharge unit according to the present invention.

### MODE FOR CARRYING OUT THE INVENTION

Hereinafter, embodiments of the present disclosure are described in more detail with reference to accompanying drawings and regardless of the drawings symbols, same or similar components are assigned with the same reference numerals and thus overlapping descriptions for those are omitted. In the following description, detailed descriptions of well-known functions or constructions will be omitted since they would obscure the disclosure in unnecessary detail.

It will be understood that the terms “first” and “second” are used herein to describe various components but these components should not be limited by these terms. These terms are used only to distinguish one component from other components.

The terms of a singular form may include plural forms unless referred to the contrary.

In this application, each process described may be performed regardless of the listed order, except for the case in which it has be performed in the listed order due to a special causal relationship.

In this application, the terms “comprises” or “having” are intended to indicate that there is a feature, number, step, operation, component, part, or combination thereof described in the specification, and one or more other features. It is to be understood that the present invention does not exclude the possibility of the presence or the addition of numbers, steps, operations, components, components, or a combination thereof.

Furthermore, hereinafter, the meaning that the thickness, width, or length of a certain component is the same means that the thickness, width, or length of first component is within the 10% margin of error compared with the thickness, width, or length of a different second component in consideration of process errors.

Hereinafter, a formulation cartridge assembly according to an embodiment of the present invention, a formulation dispenser having the same, and a formulation cartridge control unit will be described with reference to the accompanying drawings.

In the present specification, the formulation may be made of a health supplement or medicine such as a nutritional supplement in a solid form suitable for the purpose or use, and the shape of the formulation may have various shapes such as round, oval, cylindrical, polygonal, etc.

A size of the formulation, for example, a maximum diameter or maximum length may be, for example, 1 mm to 7 mm, but is not limited thereto, and the size of the formulation may be changed as necessary.

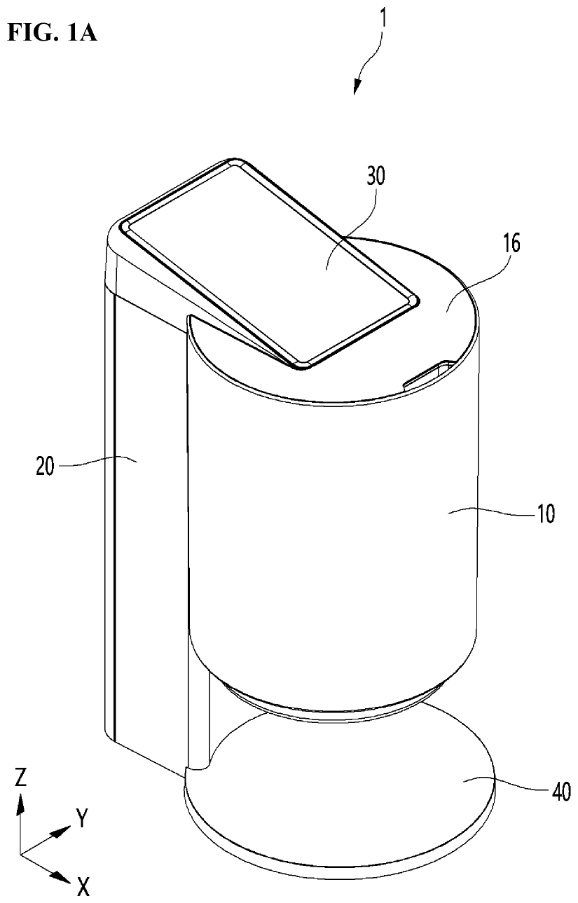

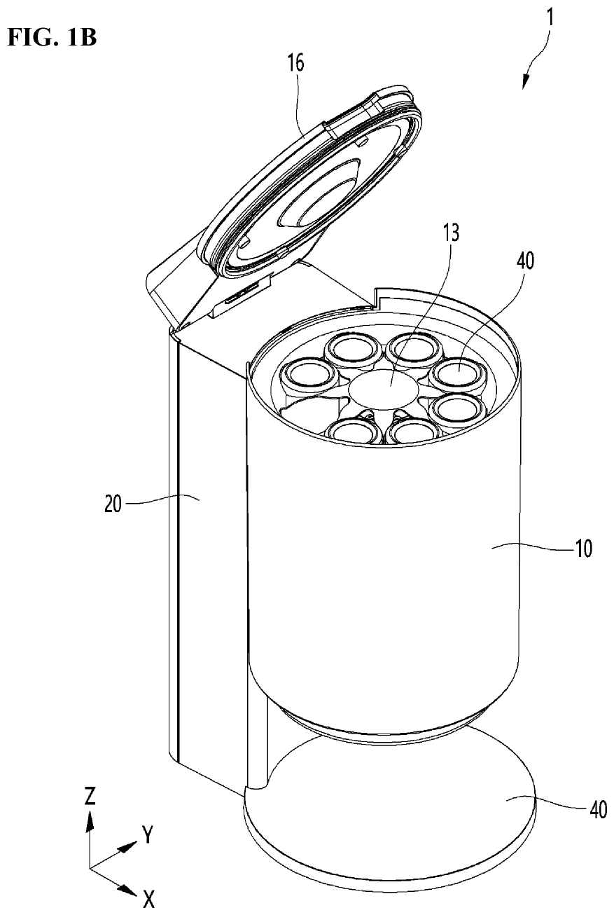

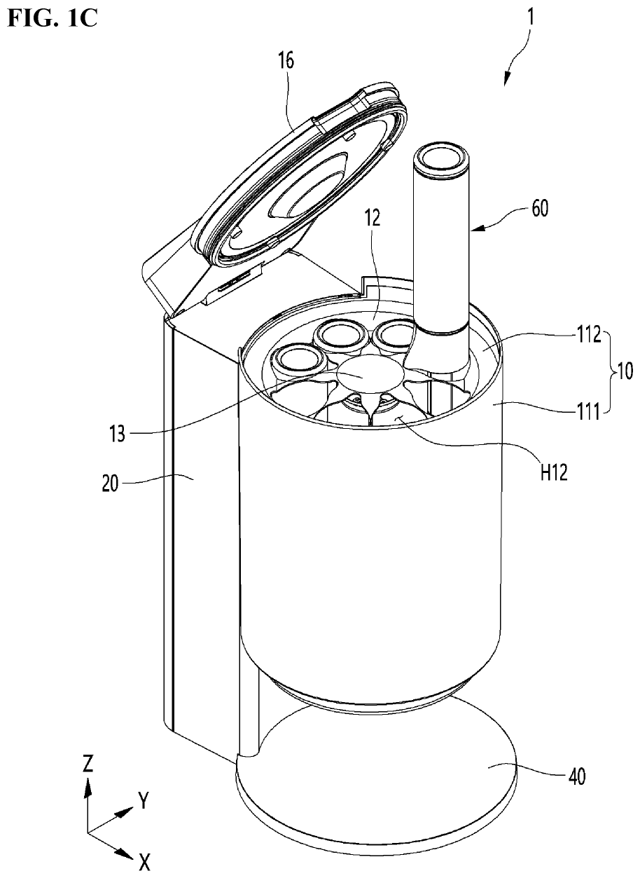

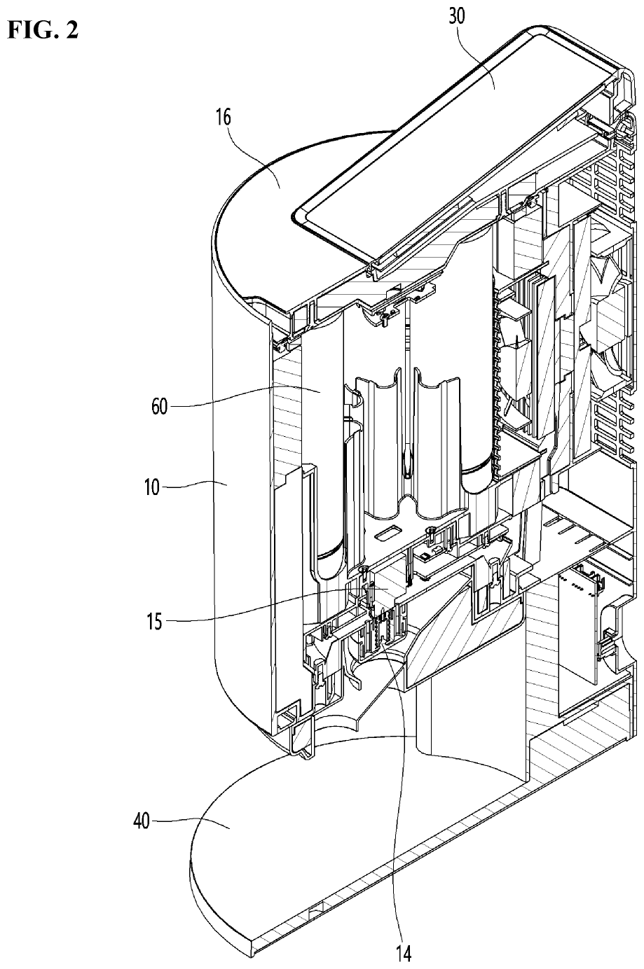

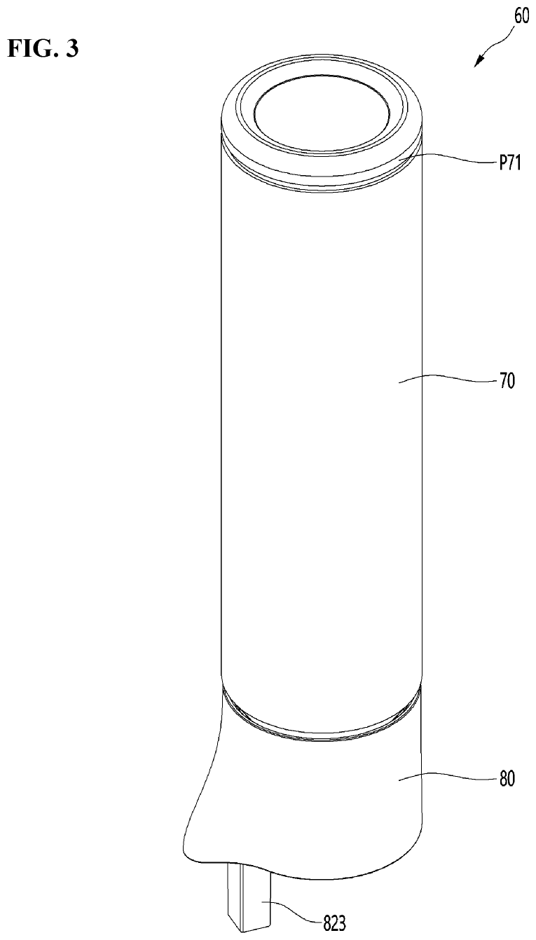

First, an example of a formulation dispenser having a formulation cartridge assembly according to an embodiment of the present invention will be described with reference to FIGS. 1a to 2.

FIGS. 1a to 1c are view for explaining a formulation dispenser according to an embodiment of the present invention. More specifically, FIG. 1a is a perspective view of an overall outer appearance of the formulation dispenser, FIG. 1b is a perspective view illustrating a state in which an upper cover of the formulation dispenser is opened, and FIG. 1c illustrates a state in which a formulation cartridge assembly is separated from an accommodation hole of the formulation dispenser.

FIG. 2 illustrates a vertical cross-section of the formulation dispenser according to an embodiment of the present invention.

In the present specification, for convenience of description, based on a formulation dispenser 1, a direction that is directed in a forward or backward direction of the formulation dispenser 1 is defined as a first direction x, a direction that is directed in a direction crossing the first direction x is defined a second direction y, and a direction that is directed in a direction perpendicular to the first direction x and the second direction y is defined as a third direction z.

Thus, based on the formulation dispenser 1 illustrated in FIG. 1a, the first direction x may be the forward and backward direction of the formulation dispenser 1, the second direction y may be a left and right direction of the formulation dispenser 1, and the third direction z may be a height direction of the formulation dispenser 1.

As illustrated in FIGS. 1a to 1c, an example of the formulation dispenser 1 according to an embodiment of the present invention may include an accommodation unit 10, a main body 20, a device terminal 30, and a support 40.

The accommodation unit 10 may be a portion in which a plurality of formulation cartridge assemblies 60, in which formulations are accommodated, respectively, are inserted and accommodated, and may be disposed at a rear side of the formulation dispenser 1 in the first direction x of the formulation dispenser 1.

For example, the accommodation unit 10 may have a substantially cylindrical shape, may extend to be elongated along the third direction z, and may have a circular planar shape. Thus, a side surface of the accommodation unit 10 may have a curved surface.

As illustrated in FIGS. 1b and 1c, the accommodation unit 10 may include a housing 11, an accommodation part 12 disposed in an inner space surrounded by the housing 11, and a mounted state display part 13 disposed at a central portion of the accommodation part 12 to display a mounted state of the formulation cartridge assembly 60 within the accommodation part 12.

The housing 11 may include a case 111 and an insulator 112 attached to an inner surface of the case 111.

The case 111 may be configured to protect the accommodation unit 10 and may contain a synthetic material such as plastic or a material such as a metal.

Since a shape of the case 111 is determined according to a shape of the accommodation unit 10, for example, the case 111 may have a circular planar shape and a cylindrical shape with upper and lower portions opened.

The insulator 112 may be configured to maintain an internal temperature of the accommodation unit 10 at a predetermined temperature (e.g., 5° ° C. to 15° C.) and may contain a heat insulating material having a heat insulating effect.

The accommodation part 12 may be a portion, into which the formulation cartridge assembly 60 is inserted and mounted, and may include a plurality of cartridge accommodation holes H12. In this embodiment, the accommodation part 12 may be made of a synthetic material.

In an alternative example, the accommodation part 12 may contain a heat insulating material, and in this case, the thermal insulation effect of the accommodation unit 10 may be further improved by the accommodation part 12.

As illustrated in FIGS. 1b and 1c, one formulation cartridge assembly 60 may be inserted into each of the plurality of cartridge accommodation holes H12, and the formulation cartridge assemblies 60 may be arranged radially around the center of the accommodation part 12.

In addition, for example, the plurality of cartridge accommodation holes H12 may be arranged in a circular shape at the same distance from the center, and the distance between two adjacent cartridge accommodation holes H12 may also be the same.

Thus, when the formulation is discharged from each formulation cartridge assembly 60 inserted into each of the plurality of cartridge accommodation holes H12, a time for which the corresponding formulation is discharged from each formulation cartridge assembly 60 toward the support 40 that is the outside of the formulation dispenser 1 may be the same.

A shape and size of each cartridge accommodation hole H12 are all the same, and also, the shape and size of each cartridge accommodation hole H12 may be determined according to the planar shape of the formulation cartridge assembly 60 to be inserted.

As illustrated in FIGS. 1b and 1c, an accommodation guide hole H121 that guides an insertion direction of the formulation cartridge assembly 60 may be provided at one side of the cartridge accommodation hole H12.

Here, the accommodation guide hole H121 may have a shape protruding toward the center of the cartridge accommodation part H12, that is, toward the mounted state display part 13. As illustrated in FIGS. 1b and 1c, the cartridge accommodation hole H12 and the accommodation guide hole H121 may be connected to communicate with each other.

Thus, since the user quickly and accurately determines the insertion direction of the formulation cartridge assembly 60 to be inserted using the accommodation guide hole H121, a smooth insertion operation of the formulation cartridge assembly 60 may be performed to improve the user's convenience.

In FIGS. 1b and 1c, the number of plurality of cartridge accommodation holes H12 may be, for example, 8, but is not limited thereto, and may be changed so that the number of plurality of cartridge accommodation holes H12 is more or less than 8.

As the number of formulation cartridge assemblies 60 accommodated in the accommodation part 12 increases, the number of formulations T10 discharged per unit time from the formulation dispenser 1 may also increase.

For example, each formulation cartridge assembly 60 may discharge 5 to 10 or more formulations per second at a high speed, and as the number of formulation cartridge assemblies 60 inserted into the formulation dispenser 1 increases, the number of formulation per second, which is discharged from the formulation dispenser 1 may also increase. For example, the number of formulations T10 discharged from the formulation dispenser 1 once may be between 25 and 250.

The mounted state display part 13 may be disposed at the center of the accommodation part 12 and surrounded by the plurality of cartridge accommodation holes H12.

The mounted state display part 13 may include a plurality of light emitting parts such as light emitting diodes, and the number of mounted state display parts 13 may be the same as the number of cartridge accommodation holes H12 and be electrically connected to a control module (not shown).

For the operation of the mounted state display part 13, a mounting detection part (not shown) for detecting whether the corresponding formulation cartridge assembly 60 is normally mounted may be disposed in each cartridge accommodation hole H12.

Thus, when the formulation cartridge assembly 60 corresponding to each cartridge accommodation hole H12 is normally mounted, the control module may output a first driving signal to the corresponding light emitting part corresponding to the corresponding cartridge accommodation hole H12 to emit light having a predetermined first color (e.g., green).

However, if the formulation cartridge assembly 60 corresponding to the cartridge accommodation hole H12 is not normally mounted or is empty, the control module may output a second driving signal to the light emitting part corresponding to the corresponding cartridge accommodation hole H12 to emit light having a predetermined second color (e.g., red) different from the first color.

As a result, since the user visually checks the mounted state of each formulation cartridge assembly 60, the formulation cartridge assembly 60 may be mounted in an accurate state.

In this embodiment, a lower end of each formulation cartridge assembly 60, that is, a lower end of the accommodation unit 10 of the formulation suspender 1 may be maintained in the opened state for discharging the corresponding formulation.

However, when the opened state is neglected, foreign substances such as dust or moisture may be introduced into the formulation cartridge assembly 60 from the outside through the opened portion, and due to the introduction of the foreign substances, the formulation cartridge assembly 60 and the formulations accommodated therein may be contaminated and deteriorated.

Thus, as illustrated in FIG. 2, the accommodation unit 10 may include a sealing part 14 performing a cover function that is capable of covering the lower end of the opened formulation dispenser 1, i.e., a lower end of all the formulation cartridge assemblies 60 and a sealing part driving part 15 that allows the sealing part 14 to move in a vertical direction along the third direction z.

The sealing part driving part 15 may include a motor and a motor driving circuit for driving the motor.

Thus, while the formulation is discharged from the formulation cartridge assembly 60, the sealing driving part 15 may operate according to the driving signal applied from the control module to allow the motor to rotate in a corresponding direction (e.g., clockwise direction), and thus, the sealing part 14 may descend up to a predetermined position due to the rotation operation of the motor.

Thus, the opened lower end of the formulation cartridge assembly 60 may be exposed to the outside by the descending operation of the sealing part 14, and thus, the formulation may be discharged from the formulation cartridge assembly 60 to the outside.

In addition, when the discharge operation of the formulation is completed in the formulation cartridge assembly 60, the operation of the sealing driving part 15 may be performed according to the driving signal applied from the control module to allow the motor to move in a direction (e.g., counterclockwise direction) opposite to that when the formulation is discharged.

As a result, the sealing part 14 may ascend up to a predetermined position opposite to that when the formulation is discharged, and the open lower end of the formulation cartridge assembly 60 may be closed by the sealing part 14 due to the ascending operation of the sealing part (see FIG. 2).

Thus, the formulation may be normally discharged from the corresponding formulation cartridge assembly 60 due to the ascending or descending operation of the sealing part 14 by the sealing part driving part 15 to protect the formulation and the formulation cartridge assembly 60 from the external foreign substances.

In addition, an upper cover 16 that is opened and closed by a user may be provided at an upper portion of the accommodation unit 20, that is, an upper portion of the housing 11.

A portion of the upper cover 16 may be hinged to a portion of the case 111 and may be opened by the user as illustrated in FIG. 1B.

The main body 20 may be disposed to be attached to a rear side of the formulation dispenser 1 to control the discharge of the formulation contained in each formulation cartridge assembly 60.

The main body 20 may include a refrigerating device for refrigerating the accommodation part 12 in which the plurality of formulation cartridge assemblies 60 are disposed. Although not shown in FIG. 2, the refrigerating device includes a heat dissipation part including at least one of a heat dissipation plate or a heat dissipation fan.

The heat dissipation plate may discharge heat generated in the accommodation unit 10 to the outside.

The heat dissipation fan may be connected to the control module, and thus, a rotation speed may be controlled according to a control signal applied from the control module.

Thus, the control module may determine a temperature at a corresponding position according to the temperature detection signal applied from a temperature detection part and control whether the heat dissipation fan operates and the rotation speed according to the determined temperature.

The internal temperature of the accommodation unit 10 may be maintained at a set temperature by the heat dissipation part, and thus, the formulation stored in the accommodation unit 10 may be stored at an appropriate temperature.

The device terminal 30 may be disposed at an upper portion of the formulation dispenser 1. Here, as illustrated in FIG. 1a, the device terminal 30 may be disposed above an upper portion of the accommodation unit 10 and an upper portion of the main body 20.

The device terminal 30 may control an overall operation of the formulation dispenser 1 and may be a portion on which a menu or operation status for setting operation or operation is displayed.

Thus, the device terminal 30 of this embodiment may include at least some components of the control module for controlling the operation of the formulation dispenser 1 and may also include a display panel for visually outputting data. Here, the display panel may include a touch panel through which a user's input operation is performed.

In this embodiment, the formulation dispenser 1 may determine the type of formulation containing different nutritional components that currently need by the user according to real-time body condition information input by the user through the device terminal 30 and determine the type of determined formulation and dosage (i.e., the number of times of discharge) of each to discharge formulation the corresponding type of formulation so that the user takes the formulation.

For this, the device terminal 30 may receive information on the user's physical health condition or mental health condition (e.g., fatigue, stress, exercise, drinking, premenstrual syndrome, allergic rhinitis, etc.) as current user condition information.

The current user condition information input through the device terminal 30 may be input to the control module (not shown). Thus, the control module may determine the type and dosage of the formulation to be taken currently and control the operation of the formulation dispenser 1 so that the determined amount of formulation is discharged.

As described above, in the formulation dispenser 1 of this embodiment, the type and dosage of the formulation to be taken by each user may be determined according to the current user condition information.

The support 40 may be disposed under the accommodation unit 10 so that the formulation dispenser 1 is stably disposed at a predetermined position.

Hereinafter, an example of the formulation cartridge assembly 60 mounted in the accommodation unit 10 of the formulation dispenser 1 will be described.

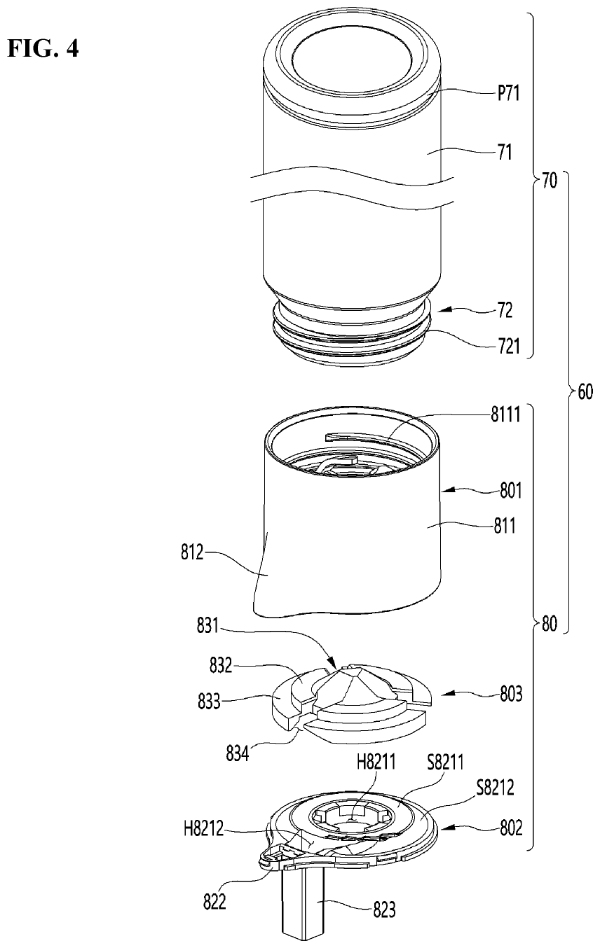

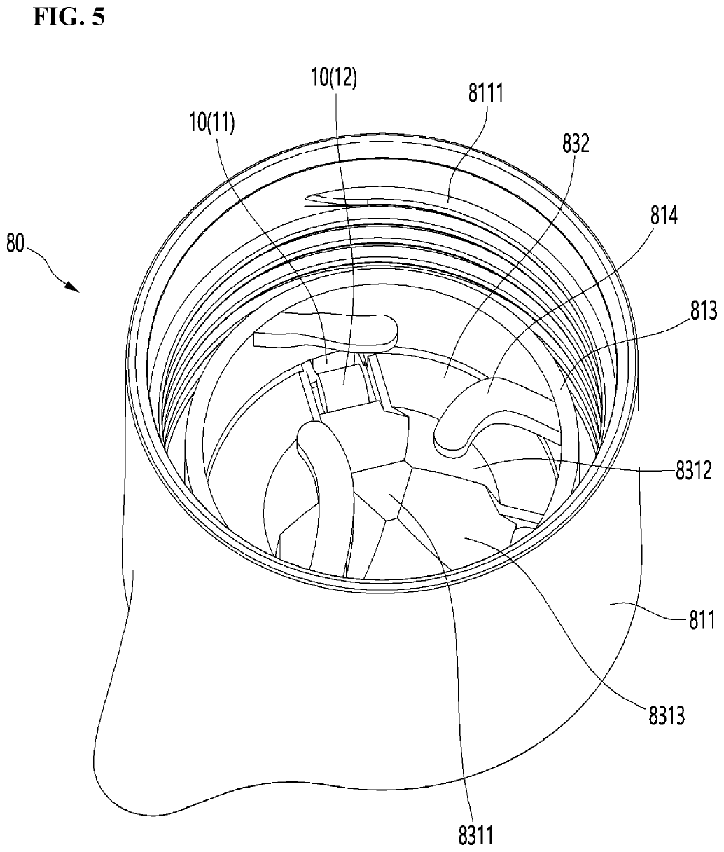

FIG. 3 is a perspective view illustrating the formulation cartridge assembly of the formulation dispenser according to an embodiment of the present invention, and FIG. 4 is an exploded perspective view of the formulation cartridge assembly illustrated in FIG. 3. FIG. 5 is a view when a discharge unit of the formulation cartridge assembly illustrated in FIG. 3 is viewed from the top.

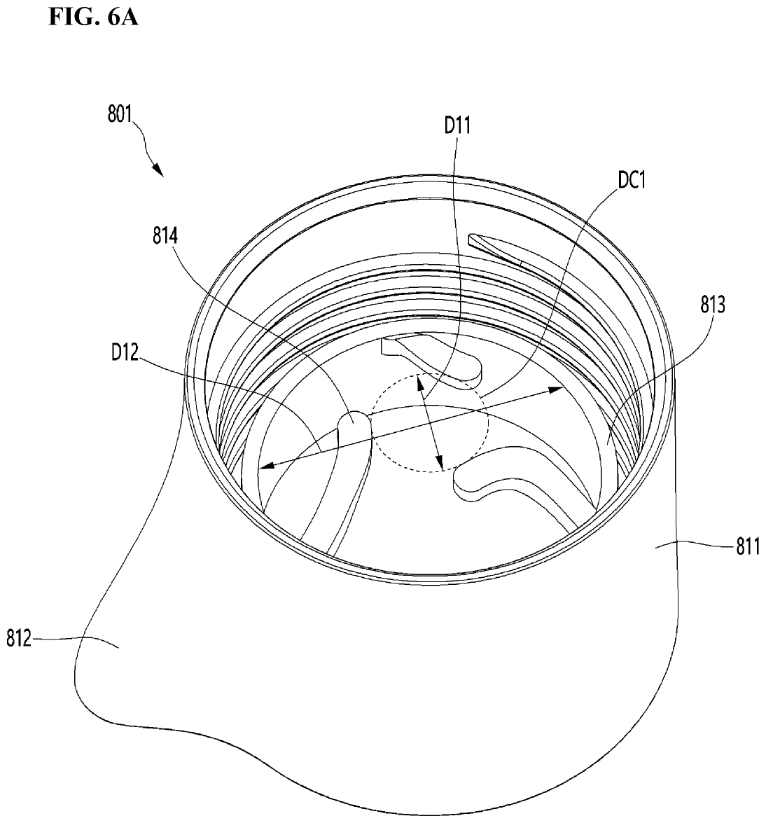

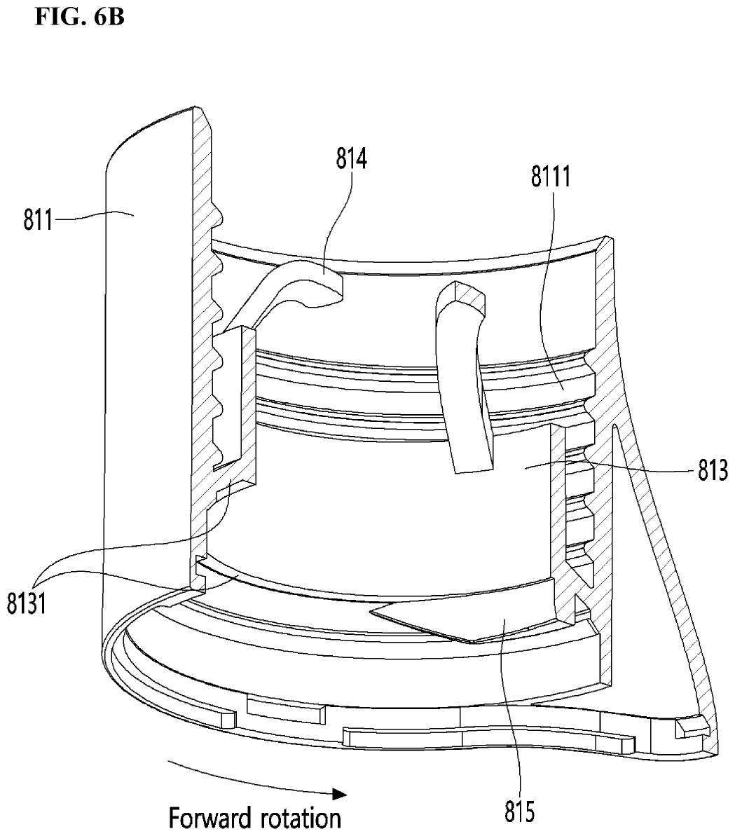

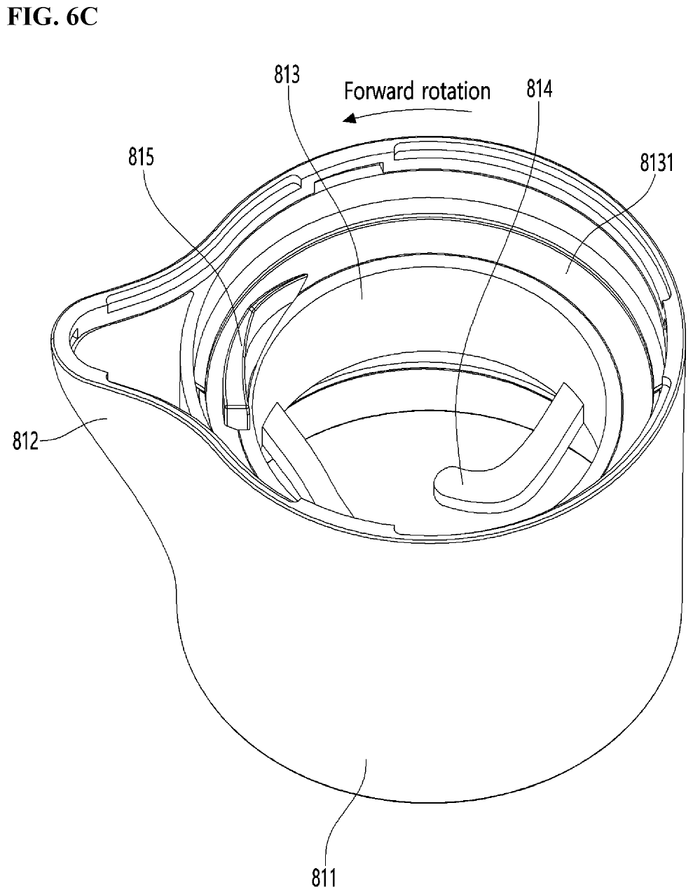

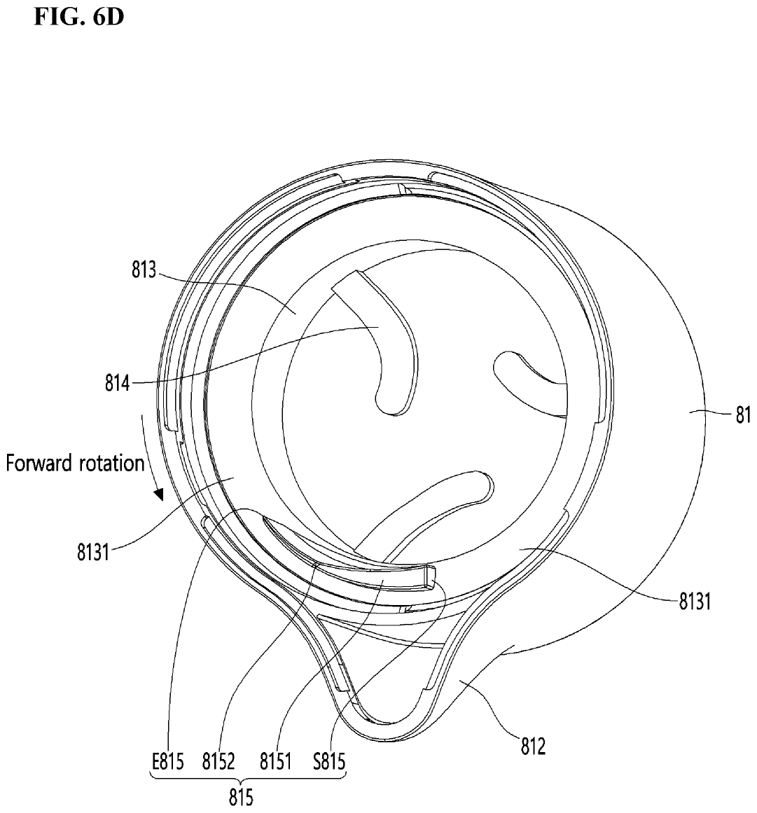

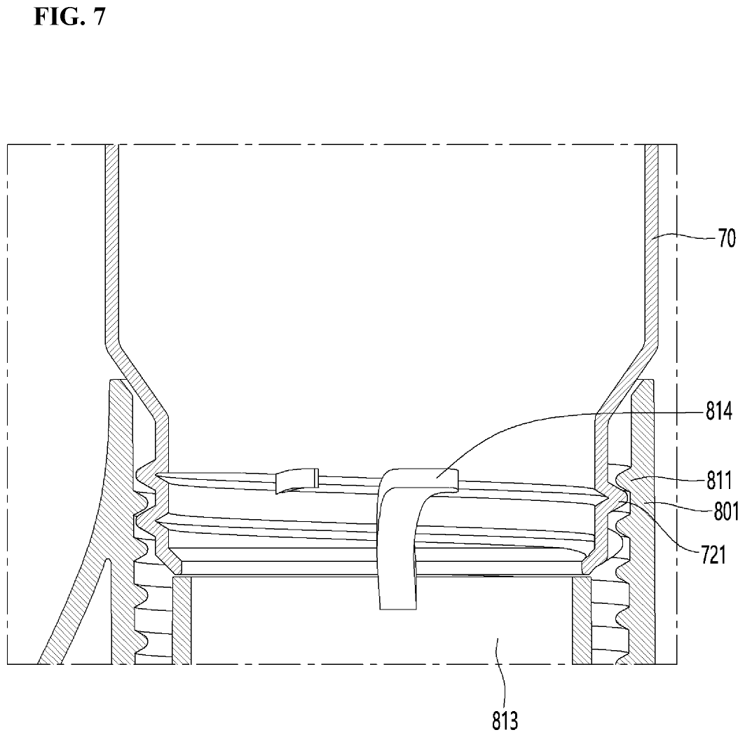

FIGS. 6a to 6d are views illustrating the housing of the formulation cartridge assembly illustrated in FIG. 3, and FIG. 7 is a view for explaining an example of a portion at which the housing and a cartridge are coupled to each other in the formulation dispenser according to an embodiment of the present invention.

The plurality of formulation cartridge assemblies 60 mounted in the accommodation unit 10 may have the same structure as each other.

An example of the formulation cartridge assembly 60, as illustrated in FIG. 3, may include a cartridge 70 in which the formulation is accommodated and a discharge unit 80 coupled to the cartridge 70.

The plurality of cartridges 70 may store different formulations T10 (e.g., vitamin A, vitamin C, lutein, omega 3, etc.) each of which contains a different nutritional component.

Hardness of the formulation T10 may be greater than or equal to a standard value (e.g., 2.4 kp), and the formulation dispenser 1 of this embodiment may have a value that is sufficient to prevent damage such as breakage or fracture due to collision or impact during the dispensing operation.

In addition, the formulation T10 of this embodiment may have a structure which has an appropriate maximum width and maximum height, and in which a ratio of the maximum width and maximum height may be formed in an appropriate range so that the formulation T10 is easily discharged to the outside through the formulation dispenser 1 according to this embodiment.

Since each cartridge 70 is coupled to one discharge unit 80, the number of discharge units 80 may be the same as the number of cartridges 70 stored in the accommodation part 12.

Thus, the operation of each discharge unit 80 may be individually and independently controlled according to the control of the control module, and thus, whether the formulation T10 stored in each cartridge 70 is discharged and the number of times of discharge may be determined.

The cartridge 70 may have a substantially circular cross-sectional shape and may have a space in which the formulation T10 is stored.

As illustrated in FIG. 4, the cartridge 70 may include a coupling part 72 for coupling the cartridge body 71 to the discharge unit 80 disposed at a lower portion thereof.

In the cartridge body 71, the lower portion coupled to the discharge unit 80 may be opened, and an upper portion facing the lower portion at an opposite side of the lower portion may be closed, and thus, the cartridge body 71 may have a cylindrical shape.

A release groove P71 formed in a circular shape along an outer surface may be disposed in an upper portion of the of the cartridge body 71, and the user may more easily withdraw the cartridge 70 inserted into the cartridge accommodation hole H12 through the release groove P71.

The coupling part 72 disposed at the lower portion of the opened cartridge body 71 may be configured to be coupled to the discharge unit 80 as already described.

As an example, since the cartridge 70 and the discharge unit 80 may be screw-coupled to each other, a screw thread 721 may be disposed on an outer surface of the coupling part 72.

The discharge unit 80 may include a housing 801 coupled to the cartridge 70, a discharge cap 802 coupled to the housing 801 at a lower portion of the housing 801, and a rotor 802 disposed between the discharge cap 802 and the housing and coupled to the discharge cap 802.

As illustrated in FIG. 5, the discharge unit 80 may discharge the cartridge 70 one by one to the outside by separating the plurality of formulations stored in the cartridge 70 through the rotation of the rotor 803 in the state in which the housing 801, the discharge cap 802, and the rotor 803 are coupled to each other.

Hereinafter, for convenience of description, when the rotor 803 rotates in the direction of discharging the formulation T10, the rotation direction may be referred to as a forward rotation, and when the rotor 803 rotates in an opposite direction to the forward rotation, the rotation direction may be referred to as a reverse rotation.

As illustrated in FIGS. 6a to 6d, the housing 801 may include a housing body 811, an accommodation guide protrusion 812 protruding from a portion of the outside of the housing body 811 (e.g., a first accommodation guide protrusion), an insertion restriction part 813 disposed on a surface of the inside (i.e., inner surface) of the housing body 811, a plurality of blocking ribs 814 disposed on a surface of the inside (i.e., inner surface) of the insertion restriction part 813, and a formulation guide protrusion 815 attached to a lower end of the insertion restriction part 813.

The housing body 811 may define an outer appearance of the housing 801 and extend in a vertical direction to have a cylindrical empty space in which the plurality of formulations are disposed at a middle portion thereof, and both upper and lower portions of the housing body 811 may be opened and extend in the vertical direction to have a cylindrical shape.

Here, the vertical direction may mean a direction perpendicular to the rotation direction of the rotor 803.

The housing body 811 may define an outer wall of the housing 801, may extend in the vertical direction, and may have a screw thread 8111 on an inner surface thereof so as to be coupled to the cartridge 70 disposed thereabove.

Thus, the cartridge 70 may be screw-coupled to the housing body 811 by the screw thread 711 of the cartridge 70 and the screw thread 8111 of the housing body 811.

The first accommodation guide protrusion 812 may be configured to guide the insertion direction of the formulation cartridge assembly 60 inserted into the cartridge accommodation hole H12 and be inserted into the accommodation guide hole H121 of the cartridge accommodation hole H12.

The discharge hole H8212 of the discharge cap 802 may be disposed adjacent to the inside of the first accommodation guide protrusion 812. Thus, the user may easily determine the position of the discharge hole H8212 from the position of the first accommodation guide protrusion 812.

The first accommodation guide protrusion 812 may have a shape corresponding to the shape of the accommodation guide hole H121, which is connected to communicate with the cartridge accommodation hole H12, and may have, for example, a substantially triangular side shape.

Thus, the user may determine the insertion direction of the formulation cartridge assembly 60 so that the first accommodation guide protrusion 812 is inserted into the accommodation guide hole H121 of the corresponding cartridge accommodation hole H12 and then may inserts the formulation cartridge assembly 60 into the corresponding cartridge accommodation hole H12.

The insertion restriction part 813 may be disposed to be spaced apart from the housing body inside the housing body 811 and extend in the vertical direction.

The insertion restriction part 813 may spatially and structurally restrict an outer portion of the rotor 803 within the housing body 811 so that the remaining formulations except for the formulation to be discharged through the formulation guide hole 834 of the rotor 803 moves to the outside of the rotor 803.

Thus, as illustrated in FIG. 5, when viewed from the top of the housing body, the outer portion 833 of the rotor may be covered by the insertion restriction part, and an inner portion 832 of the rotor 803 may be exposed. Here, an interval between the insertion restriction part 813 and the inner portion 832 of the rotor 803 may be less than the width or height of the formulation.

The insertion restriction part 813 may restrict a degree of the insertion of the cartridge 70 that is screw-coupled to the housing 801. As illustrated in FIG. 7, the cartridge 70 may be screw-coupled to the housing 801 through the rotational motion in the corresponding direction until the lower end of the cartridge 70 is in contact with an upper end of the insertion restriction part 813.

Since the insertion restriction part 813 constitutes an inner wall of the housing 801 and is spaced a predetermined interval from the inner surface of the housing body 811, the insertion restriction part 813 may be disposed to be spaced apart from the housing body 811 inside the housing body 811.

Thus, when the cartridge 70 and the housing body 811 are coupled to each other, the inner space of the cartridge 70 may be connected to the inner space surrounded by the insertion restriction part 813 so as to be in a conductive state. Due to the spatial connection between the cartridge 70 and the insertion restriction part 813, the formulation T10 stored in the cartridge 70 may be discharged into the inner space surrounded by the insertion restriction part 813 by its own weight.

Since the insertion restriction part 813 is disposed to extend along the inner surface of the circular housing body 811, the housing body 811 and the insertion restriction part 813 may be spaced a predetermined interval from each other as described above.

Thus, the spaced space between the housing body 811 and the insertion restriction part 813 may be blocked, and thus, the housing body 811 and the insertion restriction part 813 may be connected to each other.

For this, the housing 801 may include a connection part 8131 disposed between a lower end of the insertion restriction part 813 and a portion of the housing body 811, which is adjacent to the lower end to block the spaced space between the housing body 811 and the insertion restriction part 813 and couple the insertion restriction part 813 to the housing body 811. The connection part 8131 may extend outward from the lower end of the insertion restriction part 813 and be connected to the housing body 811.

Due to the connection part 8131, a spaced space having a closed lower portion and an opened upper portion may exist between the insertion restriction part 813 and the housing body 811. Thus, the insertion restriction part 813 may be coupled to the housing body 811 while maintaining the spaced distance from the inner surface of the housing body 811.

As illustrated in FIG. 6b, an outer surface (i.e., bottom surface) of the connection part 8131 exposed to the outside may have an inclined surface that is inclined downward (i.e., outer lower portion) from the insertion restriction part 813 toward the housing body 811.

In this embodiment, as illustrated in FIG. 6B, the height of the upper end of the insertion restriction part 813 may be less than the height of the upper end of the housing body 811, and the height of the lower end of the insertion restriction part 813 may be greater than the height of the lower end of the housing body 811.

Thus, the entire insertion restriction part 813 may be disposed in the inner space of the housing body 811 and may not have a portion protruding to the outside of the housing body 811.

The plurality of blocking ribs 814 may protrude from the inner surface of the insertion restriction part 813 by a predetermined interval.

All of the plurality of blocking ribs 814 may protrude upward toward a central portion of the inner space of the insertion restriction part 813. Here, the interval between the two adjacent blocking ribs 814 may be the same, and the interval between the two adjacent blocking ribs 814 may gradually decrease from the inner surface of the insertion restriction part 813 to the central upper portion of the inner space.

As described above, an empty space in a plane of the insertion restriction part 813 or an empty space in the insertion restriction part 813 may be blocked by the blocking rib 814 protruding to the empty inner space of the insertion restriction part 813 may be reduced in size due to the positions of the blocking ribs 814 and may be divided into a plurality of spaces.

In addition, a maximum width D11 of a circular space DC1 defined virtually when connecting the ends of each blocking rib 814 protruding toward the inner space of the insertion restriction part 813 to a virtual line may be less than a maximum width D12 of the inner space of the insertion restriction part 813. Here, the size of the maximum width D11 may also be determined according to the approximately protruding length of the blocking rib 814.

The cartridge 70 may include a dehumidifying cloth containing a dehumidifying agent such as silica gel in order to lower internal humidity. Such a dehumidifying cloth may have a much larger volume than that of one formulation T10.

Thus, the plurality of blocking ribs 814 are used when the dehumidifying cloth inserted inside the cartridge 70 is unintentionally discharged to the outside of the cartridge 70 to fall into the inner space surrounded by the insertion restriction part 813, the plurality of blocking ribs 814 may block the dropping dehumidifying cloth to prevent the dehumidifying cloth from being introduced into the inner space of the insertion restriction part 813.

In this embodiment, the blocking rib 814 may have an inclined surface in the vertical direction toward the upper side, that is, toward the cartridge 70 disposed at the upper portion, but is not limited thereto. That is, the blocking rib 814 may have an inclined surface that is inclined toward a flat surface parallel to an installation surface of the formulation dispenser 1 or toward a lower side in the vertical direction, i.e., the discharge cap 802.

As illustrated in FIG. 6d, in the formulation guide protrusion 815 attached to protrude downward from the connection part 8131 disposed at the lower end of the insertion restriction part 813, among the formulations T11 and T12 disposed in a line at the discharge position, only the outermost formulation T11, i.e., the formulation 11 (e.g., the outermost formulation) (e.g., the first formulation) adjacent to or in contact with the inner surface of the insertion restriction part 813 may be discharged to the outside, and the formulation 12 (e.g., the inner formulation) (e.g., the second formulation) disposed closer to the inner space of the insertion restriction part 813 than the outermost formulation T11 may be prevented from being discharged.

In addition, the formulation guide protrusion 815 may protrude downward from the connection part or the insertion restriction part and may partially overlap the discharge hole.

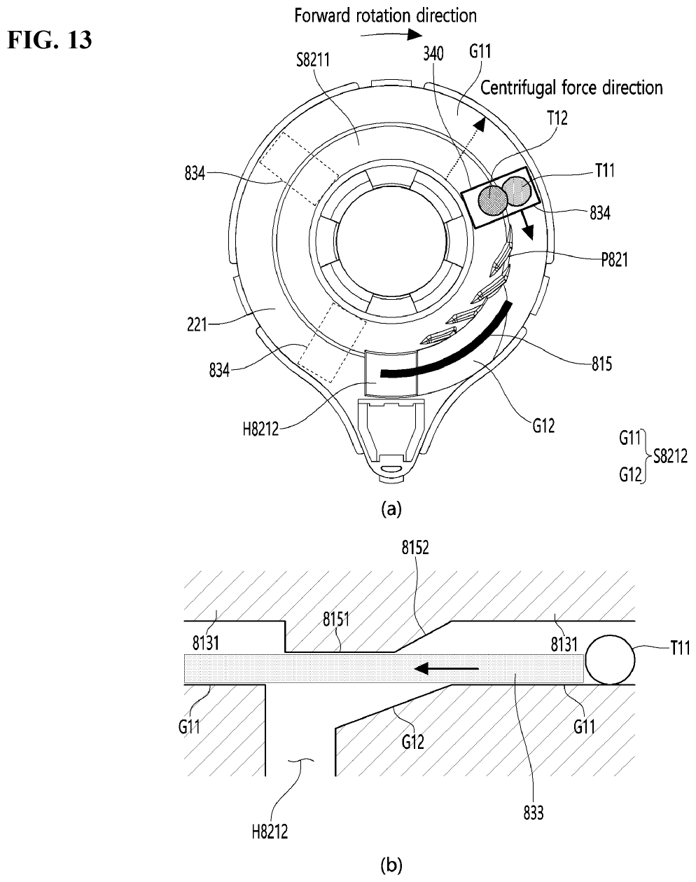

In the plurality of formulations seated in the formulation guiding hole, the first formulation disposed at the outermost portion of the formulation guiding hole may be separated from the second formulation disposed inside the first formulation. An operation in which the first formulation and the second formulation are separated by the formulation guide protrusion 815 will be described in detail with reference to FIGS. 13 to 17.

In addition, the formulation guide protrusion 815 may prevent the formulation from being discharged through the formulation guide hole and the discharge hole when the rotor stops in a state in which the formulation guide hole overlaps the discharge hole.

As illustrated in FIGS. 6c and 6d, the formulation guide protrusion 815 may be a portion of the outer surface of the connection part 8131 constituting the bottom surface of the housing 801, i.e., the bottom surface, adjacent to the discharge cap 802 may protrude downward by a predetermined thickness (i.e., protruding length).

Thus, a top surface of the formulation guide protrusion 815 may be integrally formed with the connection part 8131 on the bottom surface of the connection part 8131.

Referring to FIGS. 6b to 6d together with FIG. 4, the discharge hole H8212 may be disposed adjacent to the inside of the first accommodation guide protrusion 812, and as illustrated in FIGS. 6b to 6d, the formulation guide protrusion 815 may increase in protruding length and cross-sectional width as being closer to the discharge hole H8212.

Thus, when the rotor 803 rotates in the state in which the plurality of formulations are seated on the formulation guide hole 834, the first and second formulations may be separated from each c other while the interval between the outermost first formulation and the inner second formulation naturally increase.

Thus, when the formulation guide hole is disposed in the discharge hole, the second formulation may be blocked by the formulation guide protrusion 815, and only the first formulation may be discharged through the discharge hole H8212. Such an operation will be described in detail with reference to FIGS. 13 to 17.

For example, the protruding length of the formulation guide protrusion 815 may increase in a predetermined direction (e.g., forward rotation direction), and as a result, the bottom surface of the formulation guide protrusion 815 may be inclined upward in a predetermined direction (e.g., reverse rotation direction).

Thus, as illustrated in FIG. 6d, the protruding length of the lower end of the formulation guide protrusion 815 may be maintained constantly, and the protruding length may increase as it approaches a flat first portion 8151 and the discharge hole H8212 in the rotation direction to provide a structure in which a second portion 8152 having the inclined surface is disposed continuously. Here, the first portion 8151 may be disposed closer to the discharge hole H8212 than the second portion 8152 but overlap the discharge hole H8212 in the vertical direction.

The first portion 8151 may have the same thickness (i.e., the protruding length toward the lower side) regardless of its position, whereas the second portion 8152 may have a thickness that decreases toward the reverse rotation direction. Thus, the thickness of the first portion 8151 of the formulation guide protrusion 815 may be greater than the thickness of the second portion 8152.

Thus, a protruding length of a start end S815 of the formulation guide protrusion 815, which is an end of the first portion 8151, may be greater than a protrusion length of an end E815 of the formulation guide protrusion 815, which is an end of the second portion 8152.

Thus, as illustrated in FIGS. 6b and 6d, the protruding length of the formulation guide protrusion 815 may gradually increase as the forward rotation direction progresses.

Thus, as already described, the second portion 8152 of the formulation guide protrusion 815 may be an inclined surface of which a protrusion length gradually decreases toward the end ES815 (see FIGS. 6b and 6d).

Due to a difference in protruding length of the formulation guide protrusion 815, the outermost formulation T11 may be stably and quickly discharged to the outside when the rotor 803 rotates forward.

In addition, when the rotor 803 reversely rotates, the outermost formulation T11 may collide with the start end S815 of the first portion 8151 having a relatively large protruding length to prevent the reverse rotation of the rotor 803, thereby preventing the discharge of the outermost formulation T11 from occurring during the reverse rotation, and thus, the discharge of the outermost formulation T11 may be normally discharged only during the forward rotation.

In addition, the inner surface of the formulation guide protrusion 815 [i.e., a surface (e.g., an inner surface) disposed at an opposite side of the outer surface that is disposed adjacent to the inner surface of the housing body 811] may be an inclined surface that is inclined toward the inner surface of the housing body 811. Thus, the width of the formulation guide protrusion 815 may decrease from the first portion 8151 to the second portion 8152.

The formulation guide protrusion 815 may assist high-speed discharge of the outermost formulation T11 and prevent or minimizes the blocking when being discharged to the outside.

The formulation guide protrusion 815 will be described in more detail below.

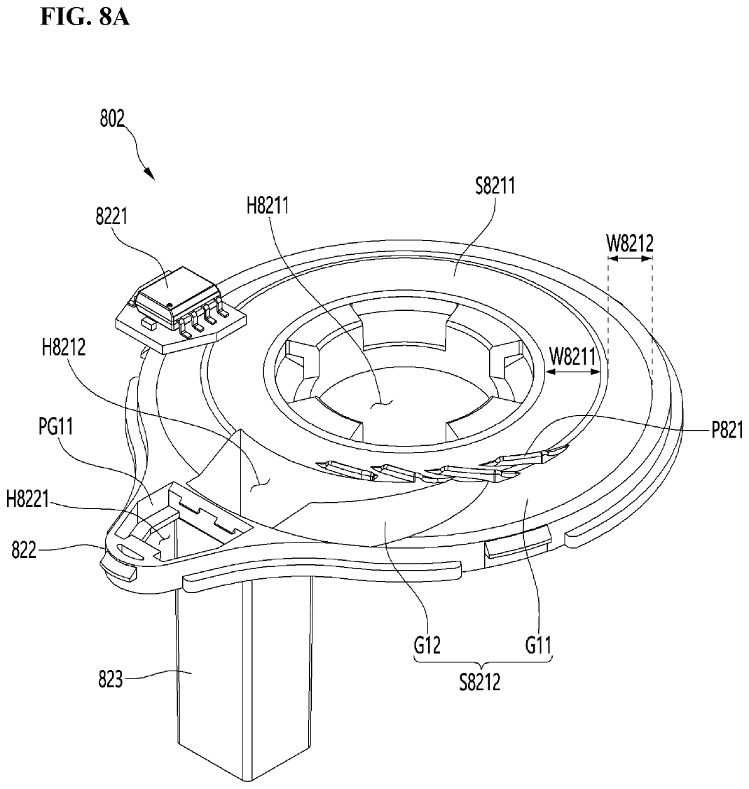

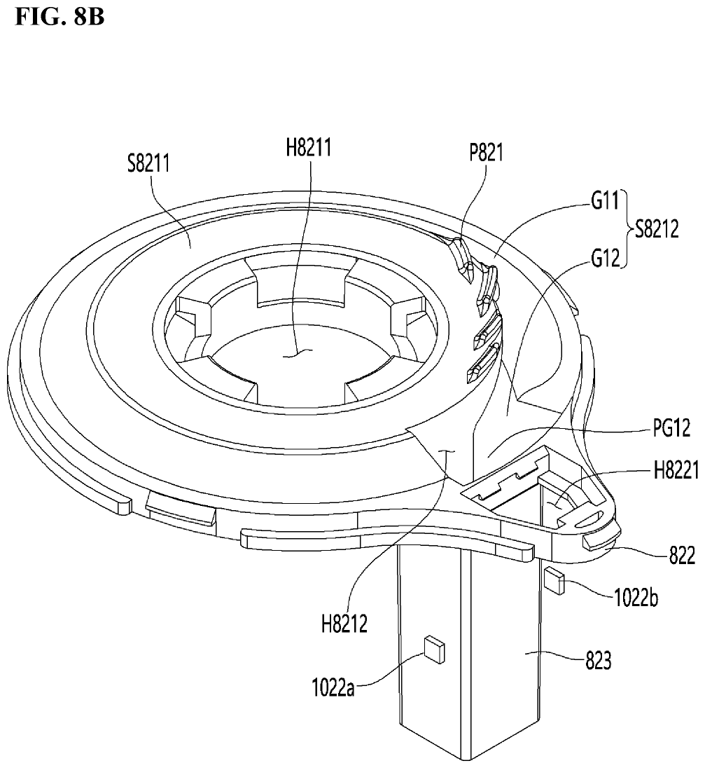

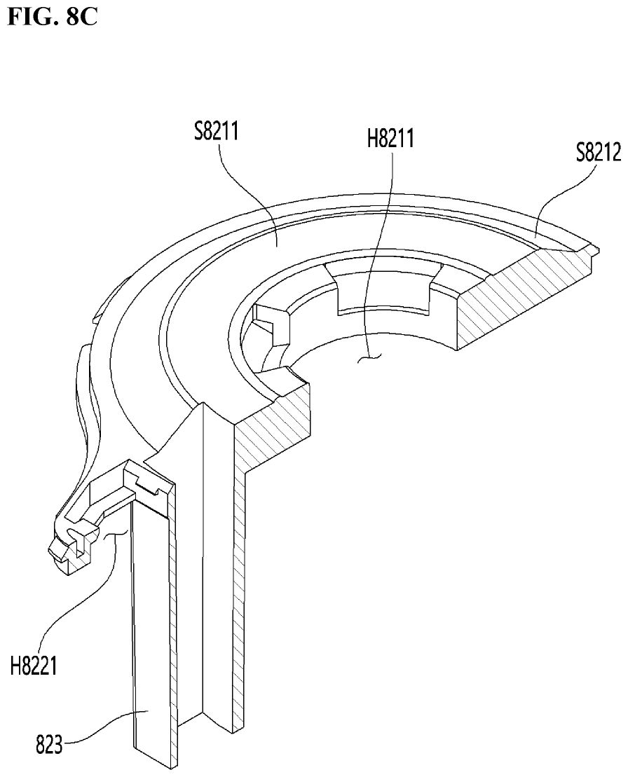

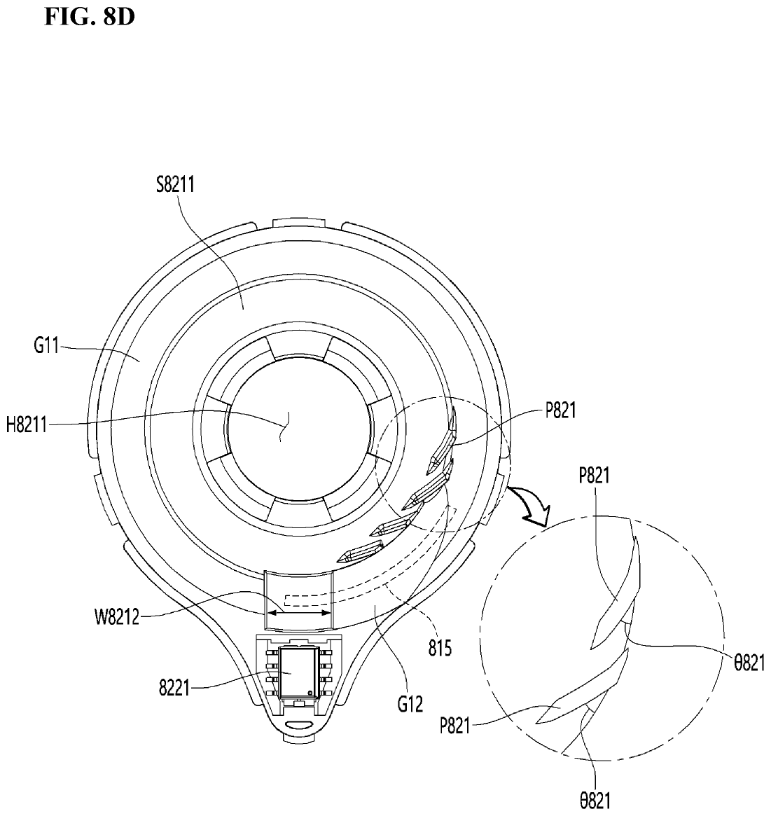

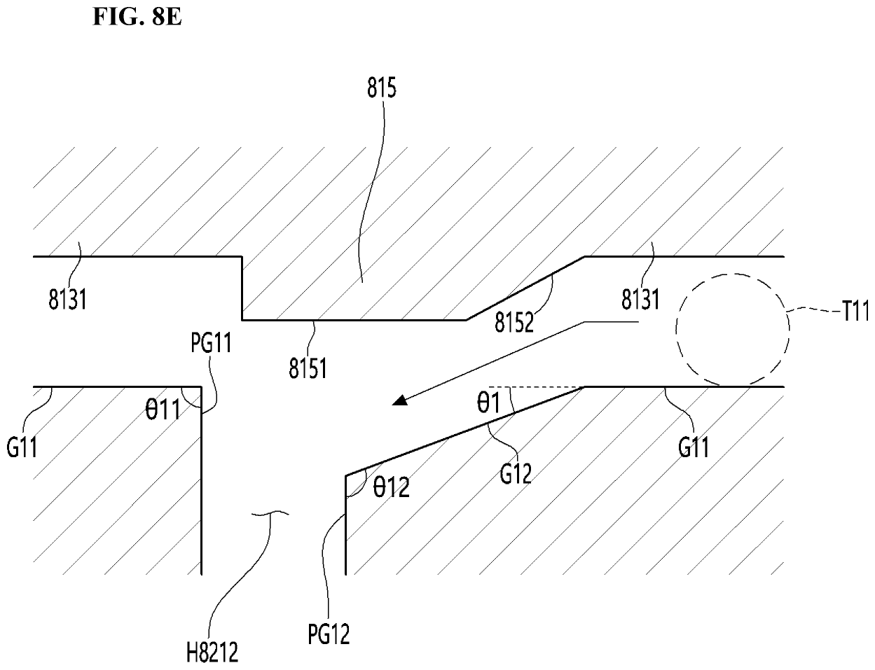

Next, the structure of the discharge cap 802 according to an embodiment will be described with reference to FIGS. 8a to 8e.

FIGS. 8a to 8e are perspective views of the discharge cap, FIG. 8c is a view illustrating a state in which the discharge cap is cut in the vertical direction, FIG. 8d is a view for explaining a position relationship between the discharge cap and the formulation guide protrusion, and FIG. 8e is a view for explaining a space between the housing and the discharge cap, through which the formulation moves by the rotor. For reference, in FIG. 8e, the rotor is omitted for convenience of understanding.

The discharge cap 802 may be coupled and fixed to the housing 801 to block a portion of the opened housing body 811 and may have a discharge hole H8212 at a portion of the edge through which the formulation is discharged.

As illustrated in FIGS. 8a to 8d, the discharge cap 802 may include a cap body 821 having a rotor insertion hole H8211 opened in a central portion and having a discharge hole H8212 at a portion of an edge, an accommodation guide protrusion 822 (e.g., a second accommodation guide protrusion) protruding outward from a portion of the edge of the cap body 821, and a discharge tube 823 extending downward from the discharge hole H8212.

The cap body 821 may include a rotor insertion hole H8211, a first guide surface S8211, a second guide surface S8212, and a discharge hole H8212.

The rotor insertion hole H8211 may have a circularly opened shape, and a portion of the rotor 803 may be inserted into the rotor insertion hole H8211 and rotatably coupled around the rotor insertion hole H8211.

The first guide surface S8211 and the second guide surface S8212 sequentially disposed outward to surround the rotor insertion hole H8211 may have a circular shape as a whole.

The first guide surface S8211 may surround the rotor insertion hole H8211, may have a constant width along an outer circumference of the rotor insertion hole H8211, and may be flat.

A plurality of discharge guide protrusions P821 may be disposed on the flat surface of the first guide surface S8211.

The plurality of discharge guide protrusions P821 may separate the outermost formulation T11 disposed on the second guide surface S8212 and the inner formulation T12 disposed on the first guide surface S8211 from each other to guide only the outermost formulation T11 to the discharge hole H8212.

The plurality of discharge guide protrusions P821 may be spaced a predetermined distance from each other and be disposed to extend from a boundary line between the first guide surface S8211 and the second guide surface S8212 toward the first guide surface S8211 by a predetermined length.

It may not be desirable for the discharge guide protrusion P821 to extend to the second guide surface S8212 for coupling with the rotor 803 disposed thereon and smooth rotation of the rotor 80.

Thus, an angle between a boundary line of the first guide surface S8211 and the second guide surface S8212 and the discharge guide protrusion P821 (e.g., an extension angle), i.e., an angle θ821 between the discharge guide protrusions P821 adjacent to the boundary line may be different from each other.

In this embodiment, the smallest extension angle θ821 may be ‘0 degree’, and here, the discharge guide protrusion P821 having the extension angle θ821 of ‘0 degree’ may be a discharge guide protrusion P821 that is closest to the discharge hole H8212 among the plurality of discharge guide protrusions P821.

An average extension angle θ821 of the plurality of discharge guide protrusions P821 may be 10 degrees to 50 degrees.

As described above, since the plurality of discharge guide protrusions P821 are mainly disposed only on the first guide surface S8211, the rotation operation of the rotor 803 may be smoothly performed without being hindered by the discharge guide protrusions 821. However, the present invention is not necessarily limited thereto.

The second guide surface S8212 may surround the first guide surface S8211, be provided with a constant width along an outer circumference of the first guide surface S8211, and include a portion is that inclined from the outer circumference of the first guide surface S9211 to the outside.

The discharge hole H8212 may be disposed on the extension line of the second guide surface S8212.

In this embodiment, the discharge hole H8212 may be disposed adjacent to the second accommodation guide protrusion 822 and disposed in line with the mounting hole H8221, in which the storage part 8221 is disposed, facing the mounting hole H8221 from the opposite side.

The storage part 8221 may store information related to the formulation cartridge assembly 60 and may be provided as a memory chip or the like.

For example, the storage part 8221 may store various information, such as at least one of the types of formulations contained in the formulation cartridge assembly 60 of which oneself is mounted, an initial number, the manufacturer of formulations, or the expiration date and expiration date of formulations.

The storage part 8221 may be electrically connected to the control unit to input the stored information to the control unit wirelessly or wired.

The second guide surface S8212 may include a first inclined portion G11 and a second inclined portion G12 along the outer circumference of the first guide surface S8211.

Here, the first inclined portion G11 and the second inclined portion G12 may have different inclined directions.

For example, the first inclined portion G11 of the second guide surface S8212 may have an inclined surface that is inclined toward an outer side of the cap body 821 and may extend from one side of the discharge hole H8212 in the forward rotation direction along the outer circumference of the first guide surface S8211.

Thus, the first inclined portion G11 may be disposed to be in contact with one side of the discharge hole H8212 and may extend circularly from one side of the discharge hole H8212 along the outer circumference of the first guide surface S8211.

In addition, the second inclined portion G12 may have an inclined surface extending from the first inclined portion G11 and inclined toward the discharge hole H212 and may extend from an end of the first inclined portion G11 along the outer circumference of the first guide surface S8211 in the forward rotation direction so as to be in contact with the other side of the discharge hole H8212.

Due to this, the second inclined portion G12 may extend circularly along the outer circumference of the first guide surface S8211 from an end point of the first inclined portion G11 and may be disposed to be in contact with the other side of the discharge hole H8212.

Thus, the second inclined portion G12 may be disposed between the discharge hole H8212 and the first inclined portion G11, and when the formulation moving along the first inclined portion G11 is discharged through the discharge hole H8212, the formulation may be more smoothly discharged due to the second inclined portion G12.

Referring to FIG. 8e, an average angle O1 formed between an extension line of the first inclined portion G11 and the second inclined portion G12 at a point at which the first inclined portion G11 and the second inclined portion G12 are in contact with each other may be between 10° and 50°. In addition, as illustrated in FIG. 8e, the second inclined portion G12 of the second guide surface S8212 and the portion 8152 of which a protruding length increases in the formulation guide protrusion 815 may overlap each other in the vertical direction and be inclined to correspond to each other.

For example, the inclined directions of the second portion 8152, which has the inclined surface of the second inclined portion G12 and the inclined direction of the second portion 8152, may be parallel to each other and thus may be inclined upward and downward.

Since the second inclined portion G12 has the inclined surface toward the discharge hole H8212, a height difference may be generated between the second inclined portion G12 and the first guide surface S8211.

When the rotor 803 rotates in the forward rotation direction, the inner portion of the discharge position of the rotor 803 in which the outermost formulation T11 and the inner formulation T12 are disposed in a line may move along the first guide surface S8211, and the outer portion of the discharge position may move along the first inclined portion G11, the second inclined portion G12, the other side of the discharge hole H8212, the discharge hole H8212, one side of the discharge hole H8212, and the first inclined portion G11.

Due to this, the outermost formulation T11 may be disposed adjacent to the inner surface of the housing 801 adjacent to the outer side of the cap body 821 by the inclined surface of the first inclined portion G11, and the outermost formulation T11 moving to the second inclined portion G12 may move more easily and quickly in the direction of the discharge port H8212 by the inclined surface of the second inclined portion G12.

For example, as illustrated in FIG. 8e, an inclination angle θ11 (e.g., the first inclination angle) between an inner surface PG11 (e.g., the first side surface) disposed at one side of the discharge hole H8212 and the first inclined portion G12 may be 85 degrees to 95 degrees, and an inclination angle θ12 (e.g., the second inclination angle) between the inner surface PG12 (e.g., the second side surface) disposed at the other side of the discharge port H8212 and the second inclined portion G12 may be 95 degrees to 175 degrees.

In the forward rotation direction, the second inclined portion G12 may be disposed to be in contact with the discharge hole H8212 before the first inclined portion G11.

That is, when the discharge hole H8212 is viewed from the second insertion guide protrusion 822, the second inclined portion G12 may be disposed to be in contact with a right side of the discharge hole H8212, i.e., the forward rotation side of the discharge hole H8212, which is the direction in which the outermost formulation T11 is discharged into the discharge hole H8212, and the first inclined portion G11 may be disposed to be in contact with a left side of the discharge hole H8212, i.e., the reverse rotation side of the discharge port, which is the direction in which the outermost formulation T11 passes through the discharge port H8212 to drop into the discharge hole H8212.

Due to a difference in inclination angle between the first inclined portion G11 and the second inclined portion G12, as illustrated in FIGS. 8a, 8b, and 8e, a height of the first side surface PG11 on which the first inclined portion G11 of the second guide surface S8212 and the discharge port H8212 meet each other may be greater than that of the second side surface PG12 on which the second inclined portion G12 and the discharge hole H8212 meet each other. That is, the height of the second side surface PG12 may be less than that of the first side surface PG11.

The first side surface PG11 and the second side surface PG12 may be side surfaces disposed between the discharge hole H8122 and the second guide surface G8212, which are adjacent to each other and also may be vertical side surfaces on which the second guide surface G8212 is in contact with each of both adjacent sides of the discharge hole H8212 and may constitute both side surfaces of the second guide surface G8212.

The first side surface PG11 may be disposed at a reverse rotation side that is a left side of the discharge hole H8212 when the discharge hole H8212 is viewed from the insertion guide protrusion 822, and the second side surface PG12 may be disposed at a forward rotation side that is a right side of the discharge hole H8212 when the discharge hole H8212 is viewed from the insertion guide protrusion 822.

Thus, as already described, when the rotor 803 rotates in the forward direction, the closer the rotor 803 approaches the discharge hole H8212, the inclination of the second guide surface S8212 increases by the second inclined portion G12. As a result, the outermost formulation T11 may be quickly and safely inserted into the discharge hole H8212.

Thus, the outermost formulation T11 may collide with the inner surface of the first side surface PG11 or the inner surface of the discharge tube 823 in an oblique direction and then naturally move toward the discharge tube 823, and thus, even though the rotor 803 rotate at a high speed, a phenomenon in which the discharge hole H8212 is blocked by the formulation T10 may be minimized.

In addition, the first inclined portion G11 may be disposed to correspond to the connection part 8131 of the housing 801 and may face the connection part 8131. Here, the inclination direction of the second guide surface S8212 and the inclination direction of the connection part 8131 may be inclined toward the outer lower side in the same manner as each other. Due to this phenomenon, the outermost formulation T11 may safely and accurately move toward the discharge hole H8212.

In addition, since the first side surface PG11 is disposed higher than the second side surface PG12, when the outermost formulation T11 is slid and dropped into the discharge hole H8212, formulation the outermost T11 may collide with the first side surface PG11 disposed at the opposite side and thus may be safely and smoothly discharged downward.

The second accommodation guide protrusion 822 may be disposed to correspond to the first accommodation guide protrusion 812 of the housing 801 and be coupled to the first accommodation guide protrusion 812.

As described above, a mounting hole H8221 in which the storage part 8221 is disposed may be disposed at a center of the accommodation guide protrusion 822.

The discharge tube 823 may be a guide tube that extends downward from the discharge hole H8212 to guide the formulation discharged through the discharge hole H8212 to the outside.

A shape of the discharge tube 823 may be determined according to the shape of the discharge hole H8212. In this embodiment, since the discharge hole H8212 has a rectangular planar shape, the discharge tube 823 may have a rectangular pillar shape.

A discharge number detection part 1022 for detecting the number of formulations discharged through the discharge hole H8212 may be disposed below the discharge hole H8212.

For example, the discharge number detection part 1022 may be disposed at each of both sides of the discharge tube 823 to detect the number of formulations moving through the discharge tube 823.

For this, the discharge tube 823 may be made of a transparent material such as transparent plastic, and the number of formulations T11 passing through the discharge tube 823 may be counted using light from the discharge number detection part 1022.

The discharge number detection part 1022 of this embodiment may be disposed below the discharge hole H8212 to detect the number of formulations T10 discharged through the discharge hole H8212 and may include a light emitting part 1022a for emitting light and light A light receiving part 1022b for receiving light.

Thus, when the formulation T11 is discharged through the discharge tube 823, the light receiving part 1022b may be blocked by the discharged formulation T11 and may not receive the light output from the light emitting part 1022a.

For this reason, the light receiving part 1022b may output a signal of a corresponding state to the control unit according to whether the light output from the light emitting part 1022a is received, and the control unit may determine whether the formulation T11 is discharged according to whether the light is received using the signal applied from the light receiving part 1022b.

For this, as illustrated in FIG. 8b, the light emitting part 1022a emitting light and the light receiving part 1022b receiving light may be disposed at both sides of the transparent discharge tube 823, that is, both sides facing each other at opposite sides, respectively. Thus, the light receiving part 1022b may receive the light from the light emitting part 1022a that is received through the transparent discharge tube 823.

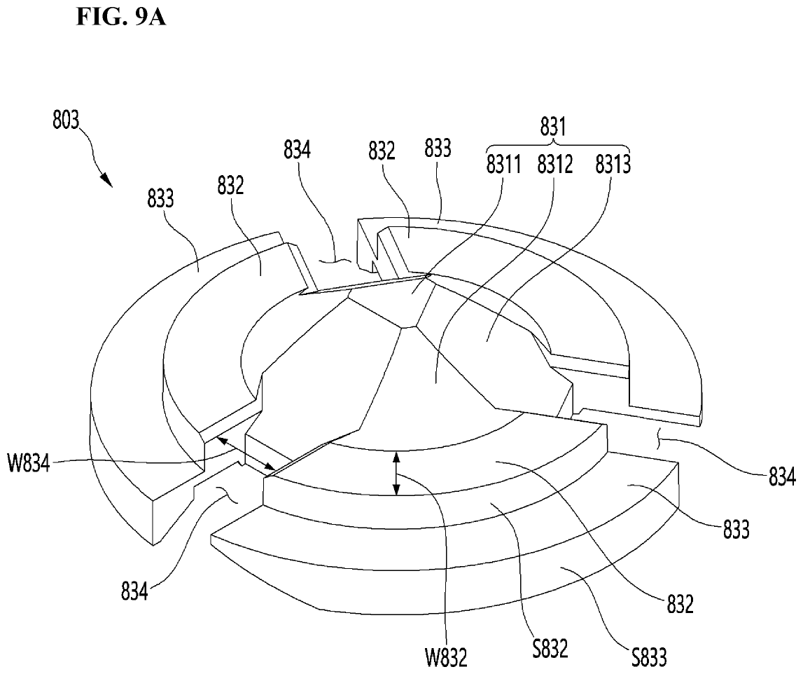

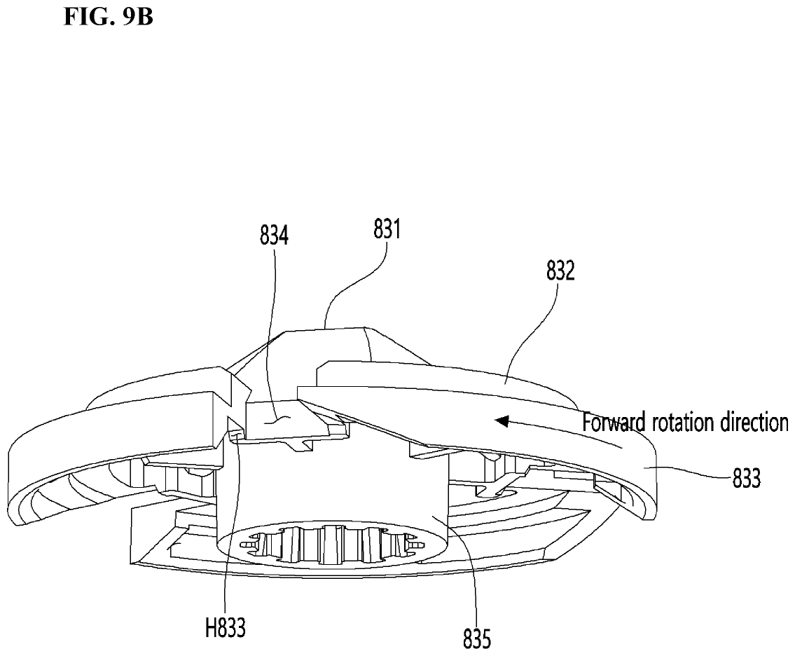

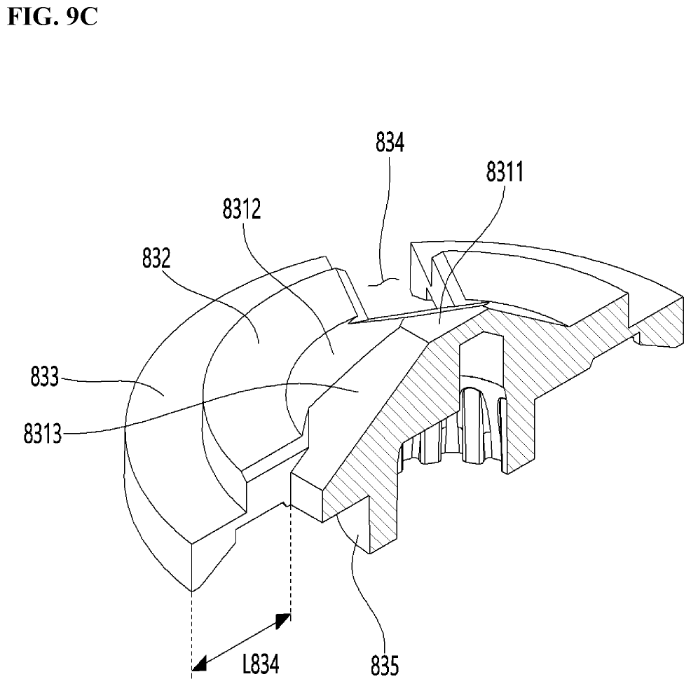

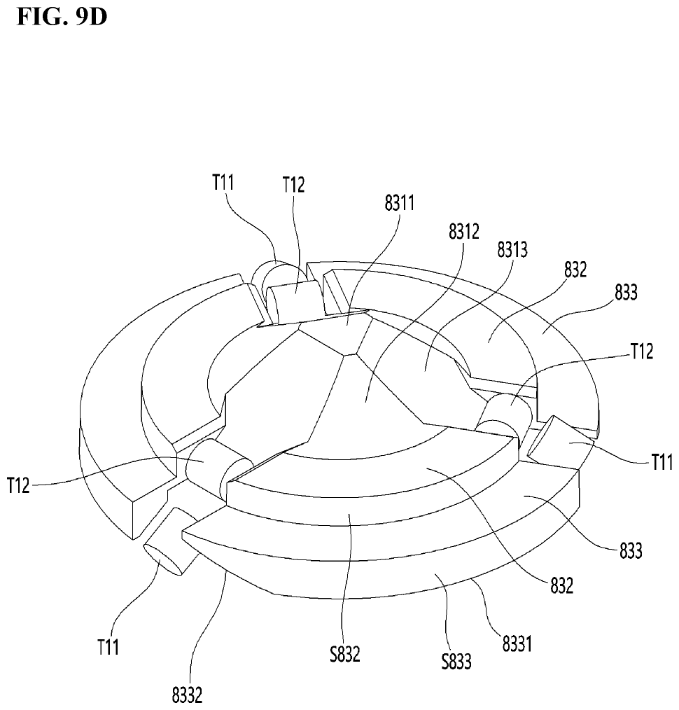

Next, the rotor 803 will be described with reference to FIGS. 9a to 9d.

FIGS. 9a to 9d are views for explaining an example of a rotor in the formulation cartridge assembly illustrated in FIG. 3. Specifically, FIG. 9a is a view when the rotor is viewed from the top, FIG. 9b is a view when the rotor is viewed from the bottom, FIG. 9c is a view illustrating a state in which the rotor is cut in the vertical direction, and FIG. 9d is a view illustrating an example in which a plurality of formulations are arranged in a line in the formulation guide hole of the rotor.

The rotor 803 illustrated in FIG. 9a may be rotatably disposed on the discharge cap 802 and may include a formulation guide hole 834 in which the formulation to be discharged through the discharge hole H8212 is seated. The rotor 803 may rotate in the housing body 811 to allow the plurality of formulations T10 disposed in the housing body 811 to move toward the discharge hole H8212 of the discharge cap 802 through the formulation guide hole 834.

While the rotor 803 rotates, the plurality of formulations T10 disposed in the inner space of the housing body 811 may be seated and loaded into the formulation guide hole 834. The formulation guide hole 834 may extend from the inside to the outside of the rotor 803, and as illustrated in FIG. 9d, a plurality of formulations including the first formulation T11 and the second formulation T12 may be seated inside to have a width and a length that are seated and arranged in a line. Thus, the outermost formulation T11 and the inner formulation T12 may be disposed side by side in a line without overlapping each other in each formulation guide hole 834 of the rotor 803.

Thereafter, when the rotor 803 continues to rotate forward in a predetermined direction to discharge the outermost formulation T11 and the inner formulation T12, which are disposed at the dispensing positions, the outermost formulation T11 and the inner formulation T12, which are disposed in the formulation guide hole 834, may also rotate along the same direction as the rotation direction of the rotor 803.

When the outermost formulation T11 disposed at the outermost side of the discharge position is disposed in the discharge hole H8212 of the discharge cap 802 by the movement of the formulations T11 and T12, the outermost formulation T11 may drop into the discharge hole H8212 and be discharged to the outside along the discharge tube 823.

That is, the rotor 803 of this embodiment is inserted into the rotor insertion hole H8211 of the discharge cap 802 and coupled to the discharge cap 802 and then rotates under the control of the control unit to push the outermost formulation T11 to the discharge hole H8212 so that the formulation is discharged to the outside.

As illustrated in FIG. 9a, the rotor 803 may have a substantially circular planar shape, and a rotor cone 831, a first rotor rail 832 connected to the rotor cone 831, a second rotor rail 833 connected to the first rotor rail 832, a plurality of formulation guide holes 834 disposed in the first and second rotor rails 832 and 833, and a driving shaft 935 disposed below the rotor cone 831.

The rotor cone 831 may be disposed at a center of the rotor 803 and may be inclined outward from the center to protrude upward at a position at which the cartridge 70 is disposed. For example, the rotor cone 831 may have a cone shape with gentle inclination.

The rotor cone 831 may perform a function of dispersing the plurality of formulations T10 disposed in the inner space of the insertion restriction part 813 so that the formulations T10 do not adhere to each other.

As illustrated in FIG. 9a, the rotor cone 831 may include, as an example, a first surface portion 831 disposed at a center thereof, a curved portion (e.g., second surface portion) 8312 connected to a corresponding portion of the first surface portion 8311, having a curved surface, and inclined toward the first rotor rail 833, and a flat surface portion (e.g., a third surface portion) 8313 connected to a corresponding portion of the first surface portion 8311, having a flat surface, and inclined toward the first rotor rail 833.

The first surface portion 8311 may have a polygonal planar shape having a plurality of sides such as a triangle.

Since the second surface portion 8312 and the third surface portion 8313 are disposed alternately around the first surface portion 8311, the second surface portion 8312 and the third surface portion 8313 may be alternately connected to corresponding sides of the first surface portion 8311.

The plurality of formulations T10 may be disposed on the rotor cone 831 and the first rotor rail 833 including the first surface portion 8311, the second surface portion 8312, and the third surface portion 8313.

When the rotor cone 831 rotates, the second surface portion 8312 and the third surface portion 8313 alternately move to be in contact with the plurality of formulations T10, thereby applying an impact to the plurality of formulations T10. In this case, in the plurality of formulations T10, the formulations T10 having surfaces attached to each other may be separated from each other by the impact.

The driving shaft part 835 may be disposed on a rear surface of the rotor cone and be inserted into the rotor insertion hole H8211 as illustrated in FIG. 9b. For this, the driving shaft part 835 may protrude downward from the rotor 803 and may have a recessed portion in order to be coupled to the driving shaft of the motor.

The first rotor rail 832 may be connected to the rotor cone and disposed along the outside of the rotor cone. More specifically, the first rotor rail 832 may be a flat surface surrounding the rotor cone 831 along an outer circumferential surface of the rotor cone 831 and be disposed on the first guide surface S8211 of the discharge cap 802 to overlap the first guide surface S8211.

Thus, the first rotor rail 832 may rotate along the first guide surface S8211.

Here, a width W832 of the first rotor rail 832 may be less than a width W8211 of the first guide surface S8211 disposed thereunder (see FIG. 8a).

The second rotor rail 833 may be connected to the first rotor rail 832, be disposed along the outside of the first rotor rail 832, and may be disposed to overlap the second guide surface S8212.

The second rotor rail 833 may have a stepped portion in a downward direction of the first rotor rail 832 and may be disposed along the outer circumference of the first rotor rail 832 to surround the first rotor rail 832.

A width W833 of the second rotor rail 833 may be greater than a width W8212) of the second guide surface S8212 disposed therebelow, for example, may be larger than the width W8212 of the second guide surface S8212 plus a partial width of the first guide surface S8211 exposed without being covered by the first rotor rail 832.

The width W8212 of the second guide surface S8212, which is the inclined surface, may not be a width of the inclined surface, which is an actual width of the second guide surface S8212, but a virtual width when connecting both ends of the second guide surface S8212 to each other with parallel lines.

Thus, not only the second guide surface S8212 but also a portion of the first guide surface S8211 that is exposed and not covered by the first rotor rail 832, may be covered by the second rotor rail 833 to overlap the second rotor rail 833.

As described above, the first rotor rail 832 and the second rotor rail 833 may have a stepped structure having a predetermined height difference, and a top surface of the second rotor rail 833 may be disposed to be spaced downward from a top surface of the first rotor rail 832.

As already described, the plurality of discharge guide protrusions P821 protruding upward, that is, toward the first rotor rail 832, may be disposed on the first guide surface S8211 of the rotor cap 802.

In order to prevent friction between the bottom surface of the second rotor rail 833 and the plurality of discharge guide protrusions P821, as illustrated in FIG. 9B, a guide protrusion insertion groove P833 may be disposed in a bottom surface of the second rotor rail 833 adjacent to an interface with the first rotor rail 832 A.

Thus, the discharge guide protrusion P821 protruding upward may be inserted into the guide protrusion insertion groove P833, and contact between the bottom surface of the second rotor rail 833 and the discharge guide protrusion P821 may be prevented. As a result, the rotor 803 may perform a smooth rotational operation without obstruction 4 the discharge guide protrusion P821.

As the rotor 803 rotates, the plurality of formulations to be discharged may be seated and arranged in a line in the formulation guide hole 834.

As illustrated in FIG. 9a, each formulation guide hole 834 may define a discharge position of each of the formulations T11 and T12 waiting to be discharged to the discharge hole H8212.

For this reason, the formulation guide hole 834, a portion of the formulation cap 802 exposed by the formulation guide hole 834 and disposed below the formulation guide hole 834, that is, a portion of the first guide surface S8211 and a portion of the second guide surface S8212, and a space surrounded by the insertion restriction part 813 may be discharge positions of the formulations T11 and T12.

Thus, as illustrated in FIG. 9d, the outermost formulation T11 and the inner formulation T12 may be disposed in a line along the extension direction of the formulation guide hole 834 without overlapping each formulation guide hole 834.

Each formulation guide hole 834 may be disposed to extend seamlessly from a corresponding end of the third surface portion 8313 over the first rotor rail 832 and the second rotor rail 833.

Portions of the first rotor rail 832 and the second rotor rail 833 may be opened by the formulation guide hole 834, and thus, each of the first rotor rail 832 and the second rotor rail 833 may have a structure that is divided into a plurality of portions by the formulation guide hole 834.

The structures of the plurality of first rotor rails 832 may be the same as each other, and the structures of the plurality of second rotor rails 833 may also be the same as each other.

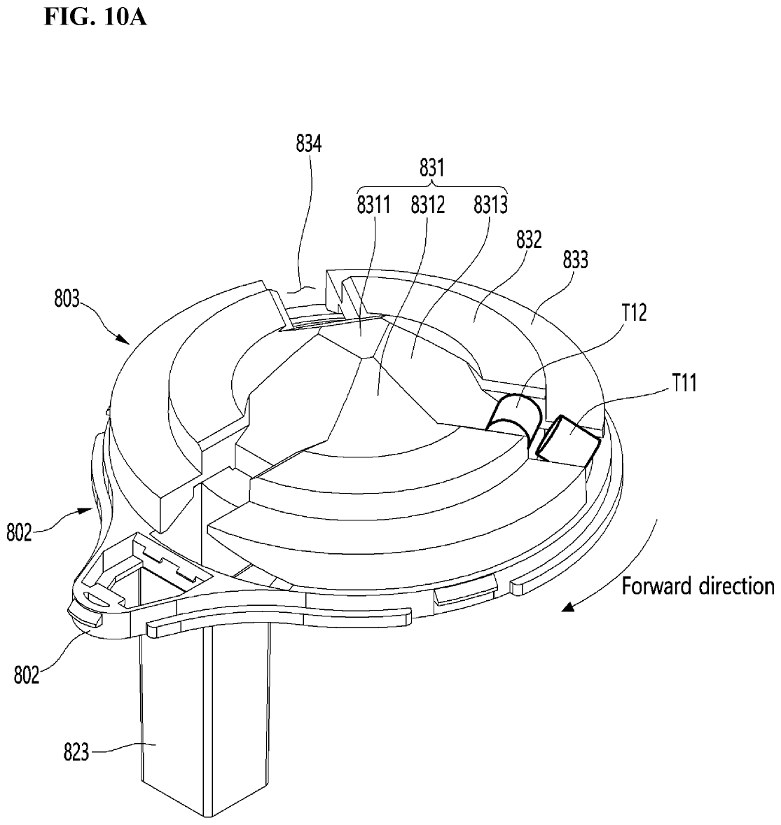

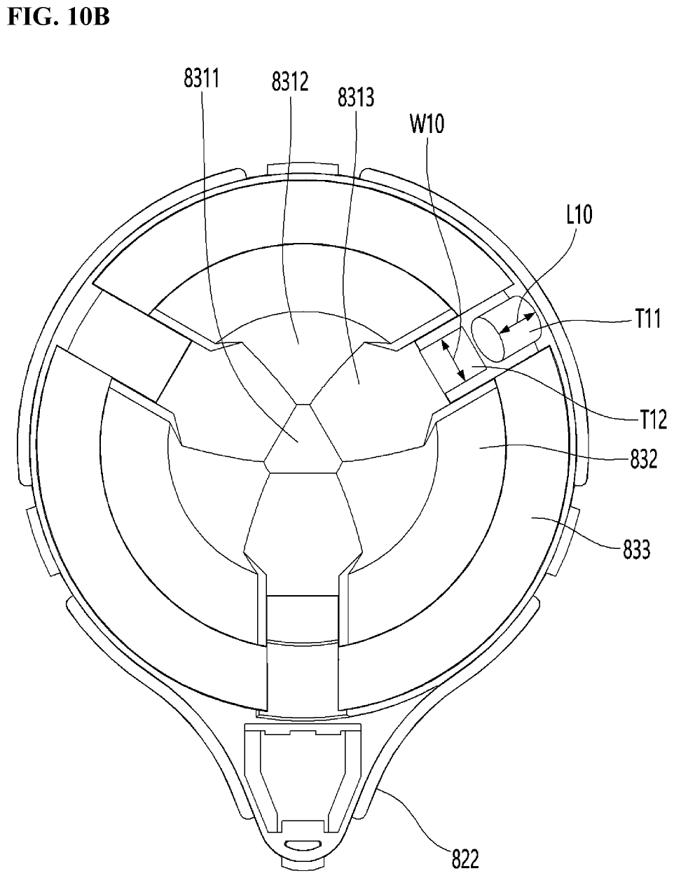

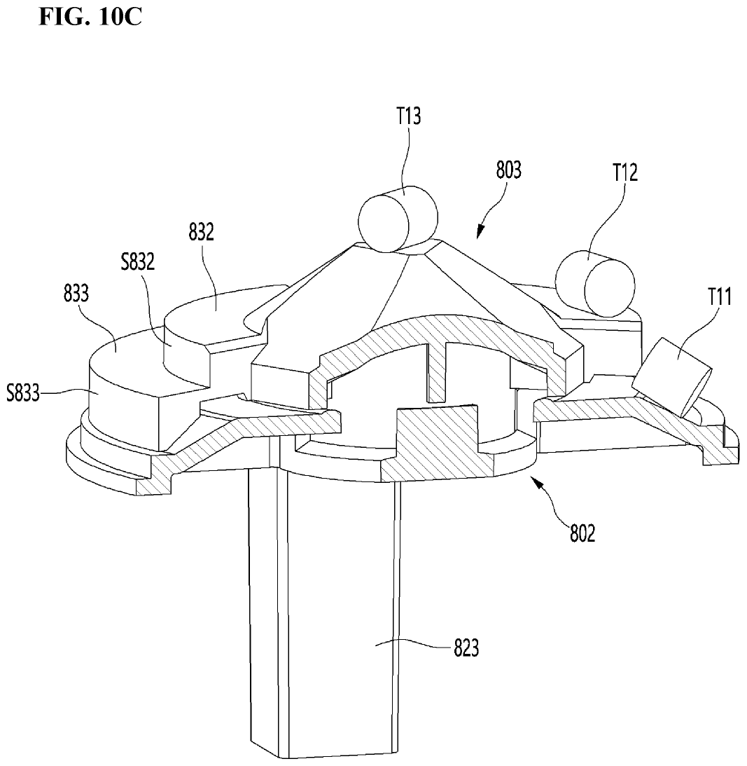

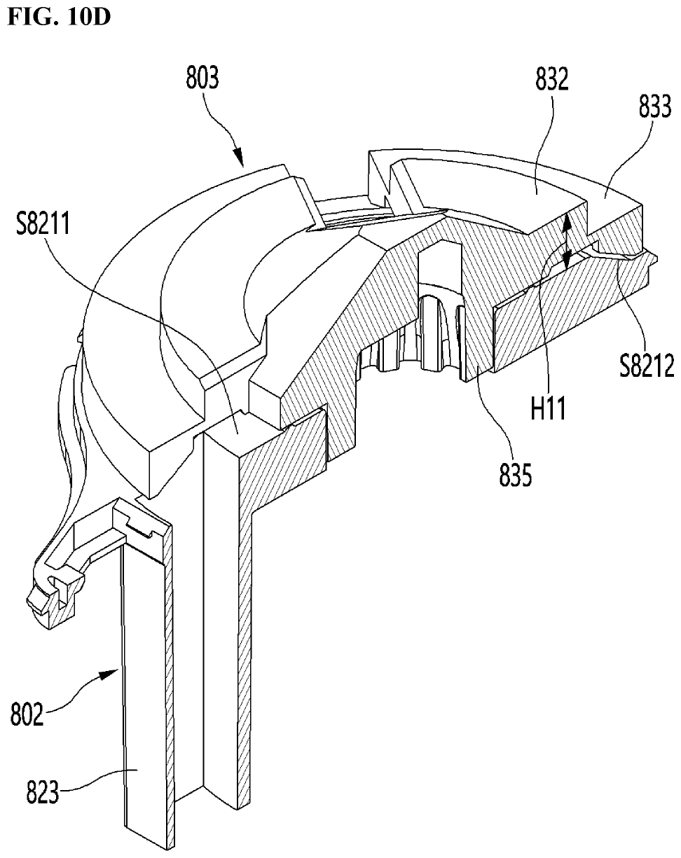

Thus, the portions of the first guide surface S8211 and the second guide surface S8212 may be exposed through the formulation guide hole 834. Furthermore, when the rotor 803 rotates, as illustrated in FIGS. 10a and 10b, at least a portion of each formulation guide hole 834 may overlap the discharge hole H8212 in the vertical direction, which is a height direction.

In this embodiment, the number of formulation guide holes 834 is three, but the present invention is not limited thereto, and the number of formulation guide holes 834 may be more or less than three.

As illustrated in FIGS. 9b and 9d, the first rotor rail 832 and the second rotor rail 833 may have side surfaces S832 and S833 extending perpendicular to the installation surface toward the lower side, respectively.

Due to the side surface S832 of the first rotor rail 832, the first rotor rail 832 may provide a stepped structure that is seamlessly connected to the second rotor rail 833.

In addition, since the side surface S832 of the first rotor rail 832 is disposed in contact with the first guide surface S8212, and the side surface S833 of the second rotor rail 833 is disposed in contact with the second guide surface S8212, the first and second rotor rails 832 and 833 may stably rotate on the first and second guide surfaces S8311 and S8212 by the side surfaces S822 and S833, respectively, so that the rotor unit 803 rotates stably.

As illustrated in FIG. 9d, a lower end of the side surface S833 of the second rotor rail 833 may have a flat surface 8331 and an inclined surface 8332.

Here, when the formulation guide hole 834 is viewed from the second insertion guide protrusion 822, the inclined surface 8332 may be disposed to be in contact with a right side of the formulation guide hole 834, that is, the forward rotation side of the formulation guide hole 834, which is the direction in which the outermost formulation T11 is discharged into the discharge hole H8212, and the flat surface 8331 may be disposed to be in contact with the reverse rotation side of the formulation guide hole 834, which is a left side of the formulation guide hole 834 facing the forward rotation side at an opposite side of the forward rotation side.

Thus, a width (i.e., protruding length) of the side surface S833 having the inclined surface 8332 may decrease toward the forward rotation side of the formulation guide hole 834.

When the outermost formulation T11 enters the second inclined portion G12 of the second guide surface S8212 adjacent to the discharge hole H8212, the outermost formulation T11 may receive force downward by the inclined surface 8332 of the second rotor rail 833, and thus, the outermost formulation T11 may quickly and accurately enter the discharge hole H8212.

FIGS. 10a to 10d are views for explaining a state in which the rotor is coupled to the discharge cap in the formulation cartridge assembly illustrated in FIG. 3.

As illustrated in FIGS. 10a and 10b, each formulation guide hole 834 in which the outermost formulation T11 and the inner formulation T12 are arranged in a line may be a hole that is completely opened to upper and lower sides. As already described, the outermost formulation T11 and the inner formulation T12 may be arranged side by side in a line from the rotor cone 831 toward the second rotor rail 833 within the corresponding formulation guide hole 834 without overlapping.

Thus, each formulation guide hole 834 has a corresponding width W834 (i.e., length in the horizontal direction) and a corresponding length L834 (i.e., vertical direction) for the arrangement of the outermost formulation T11 and the inner formulation T12 in a line.

As illustrated in FIGS. 10a and 10e, each of the formulations T10 such as the outermost formulation T11 and the inner formulation T12 may have various shapes such as a cylinder or a sphere, and each of the formulations T10 may also have a corresponding width W10 and a corresponding length L10. For example, at least one of the width W10 or the length L10 of the formulation T10 may be between 3 mm and 7 mm.

Here, the width W10 and length L10 of the formulation T10 may be different from each other within the preset range as described above. For example, a ratio of the length L10 to the width W10 of each of the formulations T11 and T12 may be between 1:0.5 and 1:1.5.

The width W834 of the formulation guide hole 834 may be greater than at least one of the width W10 or the length L10 of the formulation T10. Here, one formulation T10 in the width direction of the formulation guide hole 834 may have a width at which the formulation enters. For example, the width W834 of the formulation guide hole 834 may have a ratio value between 1.1 times and 1.5 times that of at least one of the width W10 or the length L10 of the formulation T10.

The length L834 of the formulation guide hole 834 may be greater than the width W834 of the formulation guide hole 834 and also be greater than at least one of the width W10 or the length L10 of the formulation T10. In this case, the outermost formulation T11 and the inner formulation (T12) may be arranged in a line to have a size that is capable of being loaded.

For example, the length L834 of the formulation guide hole 834 may have a ratio value between 1.5 times and 2.5 times the width W834. In addition, the length L834 of the formulation guide hole 834 may have a ratio value between 1.5 times and 2.5 times that of at least one of the width W10 or the length L10 of the formulation T10.

The length L834 of the formulation guide 834, which is set to a range less than twice that of at least one of the width W10 or length L10 of the formulation T10, may be considered for a gap between an end of the second rotor rail 833 and the outer surface of the housing body 811.

In addition, referring to FIG. 10d, a height H11 from a top surface of the first guide surface S8211 exposed by the formulation guide hole 834 to a top surface of the first rotor rail 832 (e.g., the first height) may be illustrated. Here, the first height H11 may have a size that is capable of minimizing friction or collision between the formulations T11 and T12 disposed in the formulation guide hole 834 and the other formulation T13 that is not disposed in the formulation guide hole 834 when the rotor 803 rotates.

For this, the first height H11 may have a ratio value between 0.8 times and 1.2 times of at least one of the width W10 or the length L10 of the formulation T10.

As already described, the plurality of formulations T10 may be disposed in an inner space defined by the inner surface of the insertion restriction part 813, the top surface of the rotor cone 831 of the rotor 803, and the top surface of the first rotor rail 832 (see FIG. 10c). As already described, when the housing 801 and the discharge cap 802 are coupled to each other, since the connection part 8131 is mainly disposed on the second rotor rail 833, the formulation T10 may not be disposed on the second rotor 833 of the rotor 803.

In this state, some of the plurality of formulations T10 may be inner formulations T12 disposed at an inner portion of the formulation guide hole 834 through which the first guide surface S8211 is exposed, i.e., inner formulations T12 disposed at a portion adjacent to the rotor cone 811.

Thus, as the rotor 803 rotates forward, the inner formulation T12 may move to an outer portion of the formulation guide hole 834, in which the second guide surface S8212 is exposed, that is, a portion adjacent to the outside in an opposite direction of the inner portion, and thus, the inner formulation T12 may be the outermost formulation T11 (see FIG. 10c).

Thereafter, the outermost formulation T11 disposed to move to the outer portion of the formulation guide hole 834 may move along the second guide surface S8212 due to the continuous forward rotation of the rotor 803, and when the formulation guide hole 824 is disposed above the discharge hole H8212, the outermost formulation T11 may be also disposed above the discharge hole H8212, and thus, the outermost formulation T11 may pass through the discharge hole H8212 and then be discharged to the outside through the discharge tube 823.

As a result, the formulation guide holes 834 may sequentially overlap the discharge hole H8212 disposed at the lower portion by the rotation operation of the rotor 803 to allow the outermost formulation T11 disposed at the corresponding formulation guide hole 834 to drop into t the discharge hole H8212.

In addition, since the formulation guide hole 834 is connected to the flat and inclined third surface portion 8313, the formulation T10 disposed in the space may move to the corresponding formulation guide hole 834 more quickly and accurately.

The driving shaft part 835 may be inserted into the rotor insertion hole H8211 of the discharge cap 802 so that the rotor 803 rotates.

For this, a coupling hole into which a shaft of a driving part (e.g., a motor) for rotating the rotor 803 is inserted may be disposed in the driving shaft part 835, and the connection with the driving part may be performed through the coupling hole to allow the rotor 803 to rotate forward or reverse.

Thus, the rotor 803 may be coupled to the discharge cap 802 by the driving shaft part 835.

As described above, when the discharge cap 802 is coupled to the rotor 803 and then to the housing 801, the opened lower portion of the insertion restriction part 813 of the housing 801 is blocked by the discharge cap 802 exposed by the rotor 802 and the formulation guide hole 834. As a result, the rotor 802 and some discharge caps 802 may define a bottom surface of the insertion restriction part 813 in which the formulation T10 is disposed.

In addition, when the housing body 801 and the discharge cap 802 are coupled to each other, since the first rotor rail 832 is surrounded by the insertion restriction part 813, the connection part 8131 may be disposed on the second rotor rail 833. Thus, the plurality of formulations T10 discharged from the corresponding cartridge 70 may be disposed on the top surface of the rotor cone 831 and the top surface of the first rotor rail 832 and then be restricted in movement toward the second rotor rail 833 by the insertion restriction part 813 so that the formulation T10 is not disposed on the second rotor rail 833.

A brief description of the operation of the formulation cartridge assembly 60 having such a structure is as follows.

First, the driving shaft part 835 of the rotor 803 may be inserted into the rotor insertion hole H8211 of the discharge cap 802 so that the rotor 803 is rotatably disposed above the discharge cap 802.

Due to the coupling of the discharge cap 802 and the rotor 803, the first rotor rail 832 of the rotor 803 may rotate along the first guide surface S8211, and the second rotor rail 833 of the rotor 803 may be rotatable along a portion of the first guide surface S8211 and the second guide surface S8212.

The housing 801 may be coupled to the discharge cap 802 to which the rotor 803 is coupled.

Here, the assembler assemblies the housing 801 and the discharge cap 802 so that the first accommodation guide hole 812 of the housing 801 and the second accommodation guide hole 822 of the discharge cap 802 overlap each other, and the discharge unit 80 may be assembled.

Thus, the connection part 8131 may be disposed on the second rotor rail 833, and thus, the formulation guide protrusion 815 attached to the bottom surface of the connection part 8131 may be disposed on the second rotor rail 833 to overlap the rotor rail 833.

Thus, when the rotor 803 rotates in the forward rotation direction, an end E815 of the formulation guide protrusion 815 may be disposed before the discharge hole H8212, and a start end S815 may be disposed to overlap the discharge hole H8212.

In this embodiment, as illustrated in FIG. 6d, the start end S815 of the formulation guide protrusion 815 may be disposed at a position that is ½ or more of the length (e.g., the length in the rotation direction) extending along the rotation direction of the discharge hole H8212 to overlap the discharge hole H8212, and the end E815 may be disposed before the starting of the discharge hole H8212 so as not to overlap the discharge hole H8212.

Thus, the width W8212 of the discharge hole H8212 may overlap the formulation guide protrusion 815 by ½ or more.

Due to the positional relationship between the formulation guide protrusion 815 and the discharge hole H8212, if the discharge hole H8212 and the formulation guide hole 834 do not overlap each other by a set size or more, the discharge operation of the outermost formulation disposed in the formulation guide hole 834 may not be performed.

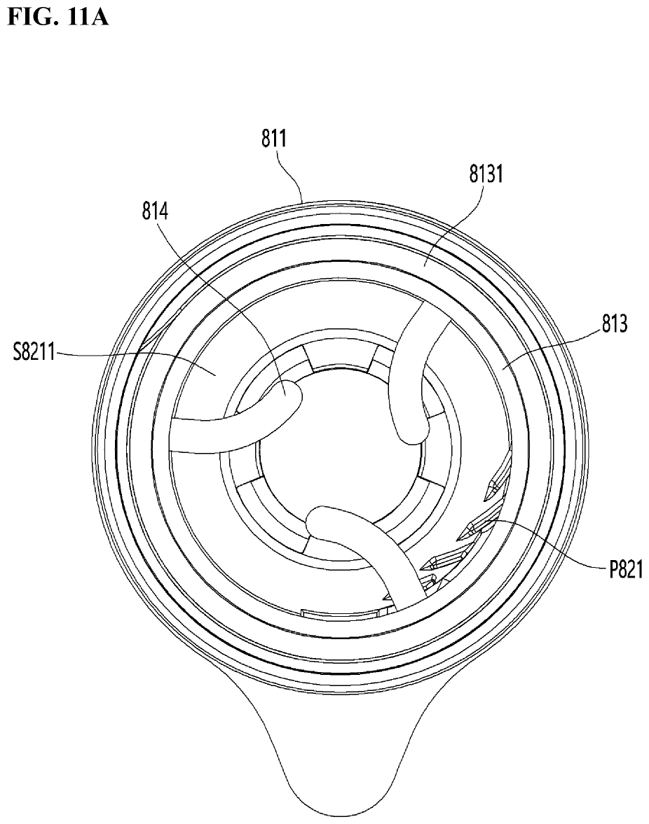

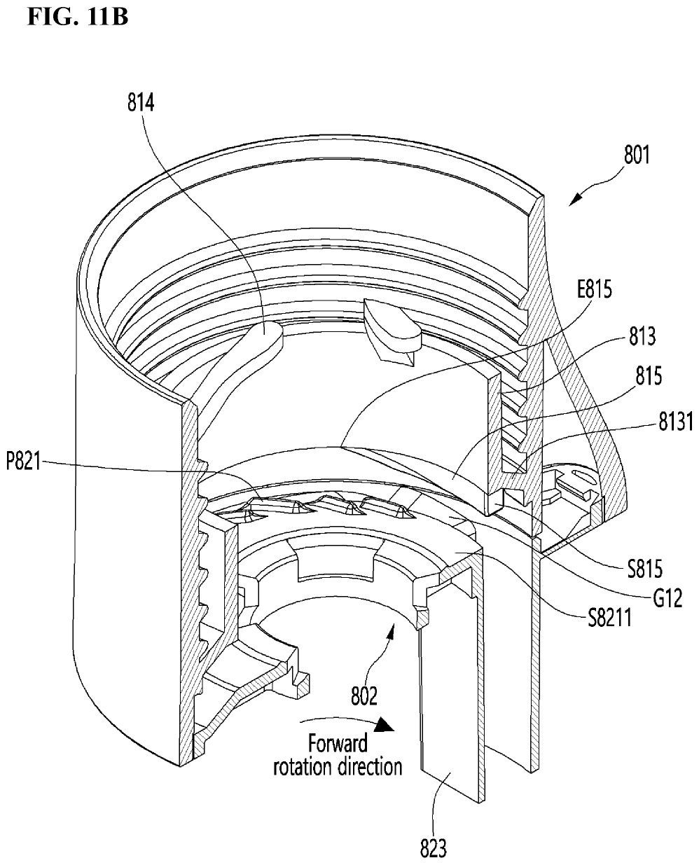

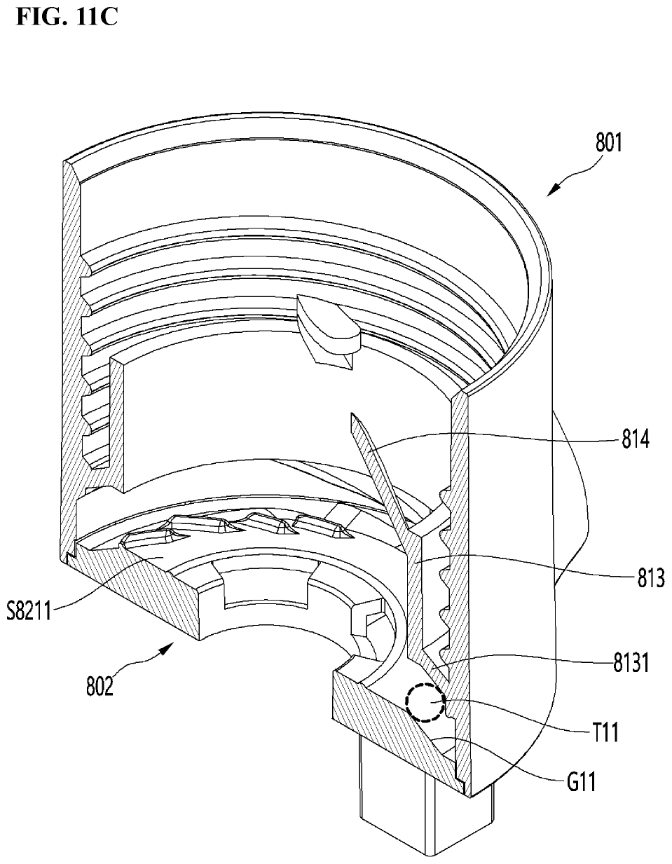

FIGS. 11a to 11c are views for explaining a coupling relationship between the housing and the discharge cap in the formulation cartridge assembly illustrated in FIG. 3. In FIGS. 11a to 11c, the rotor is omitted to explain the coupling relationship between the housing and the discharge cap, FIG. 11a is a view when viewed from the top of the housing coupled to the discharge cap, and FIG. 11b is a vertical cutaway view of the housing and the discharge cap so that a cross-section of the discharge hole is exposed, and FIG. 11c is a vertical cutaway view of a portion different from that of FIG. 11b.

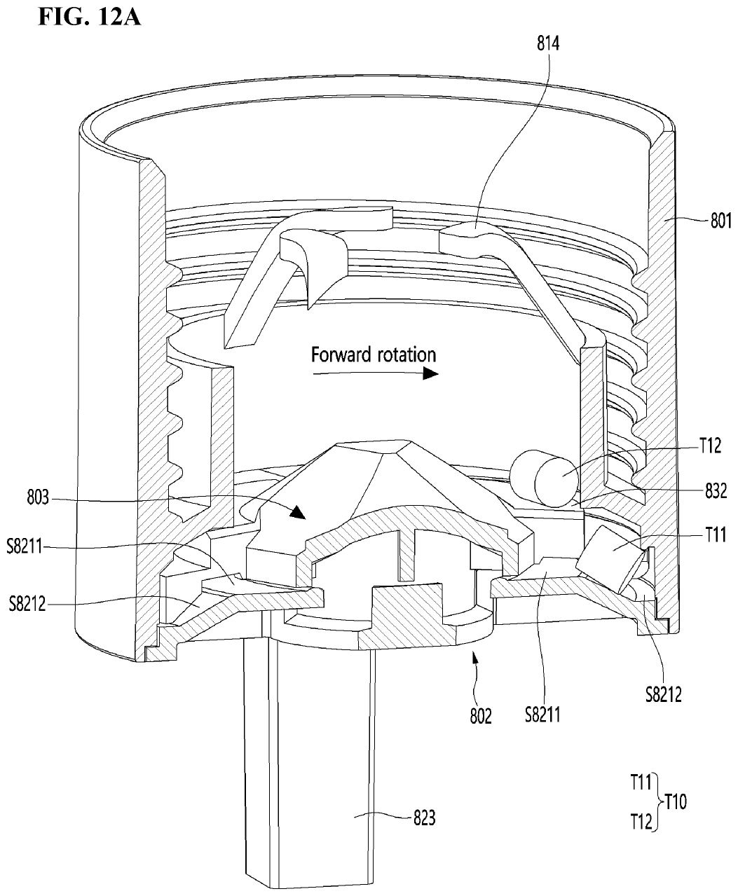

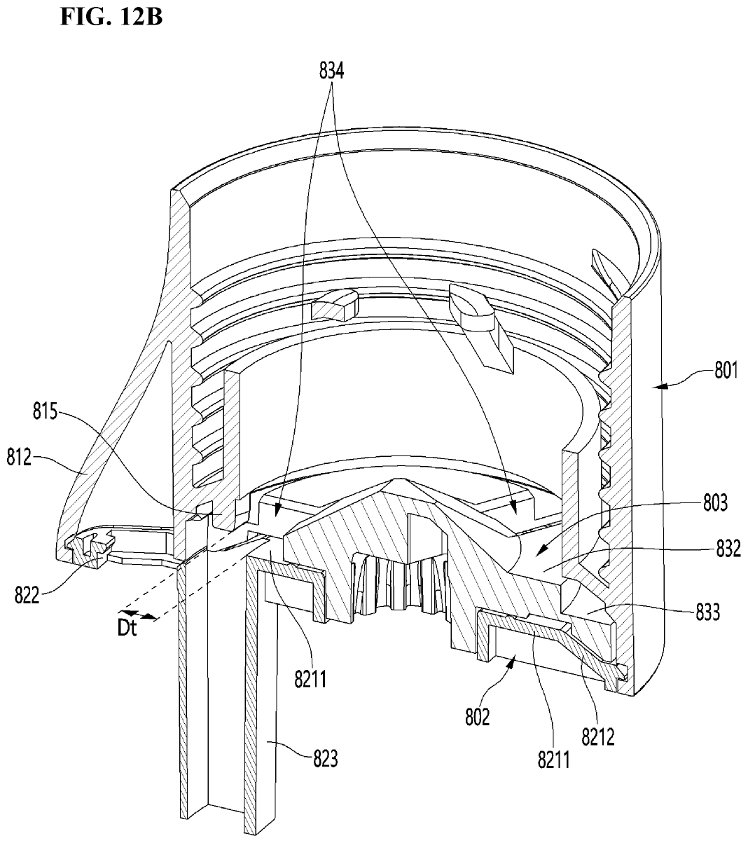

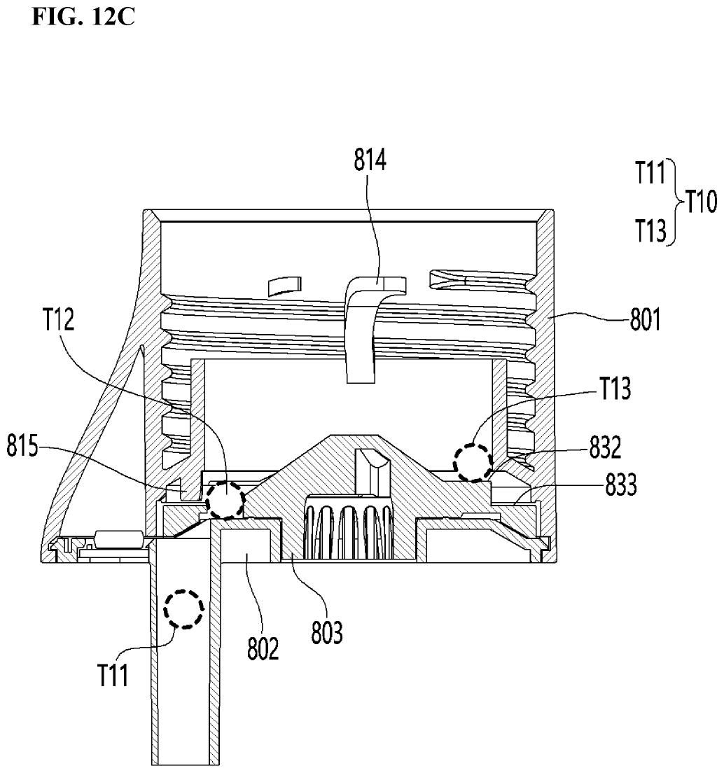

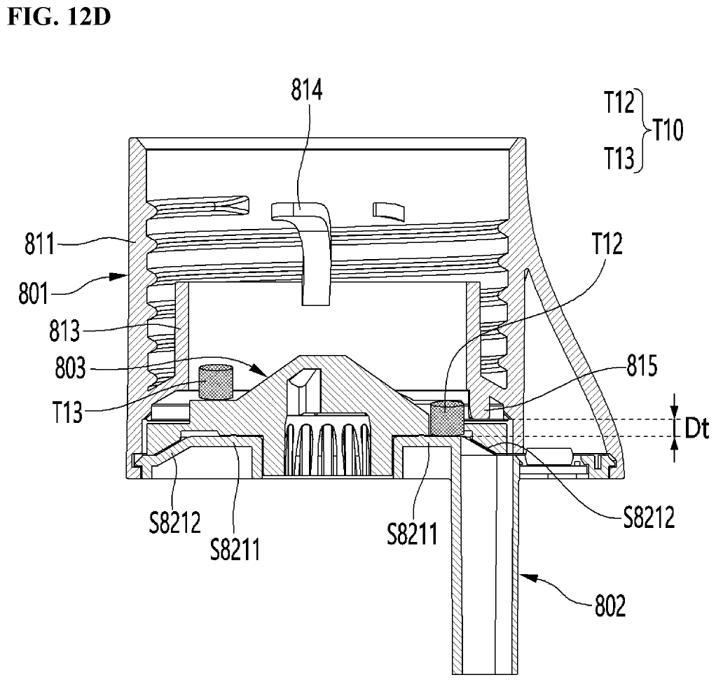

FIGS. 12a to 12d are views for explaining a coupling relationship between the housing, the rotor, and the discharge cap.

The insertion restriction part 813 may be disposed vertically adjacent to a boundary surface between the first guide surface S8211 and the second guide surface S8212. Thus, as illustrated in FIG. 11a, when viewed from the top of the housing 801, the first guide surface may be exposed to the inside of the insertion restriction part 813.

As illustrated in FIGS. 11b and 11c, the second inclined portion G12 of the second guide surface S8212 and the portion 8152 of which a protruding length increases in the formulation guide protrusion 815 may overlap each other in the vertical direction and be inclined to correspond to each other. In addition, at least some of the plurality of discharge guide protrusions P821 may be disposed at a point ahead of the position of the end E815 of the formulation guide protrusion 815. In addition, as illustrated in FIGS. 11b and 11c, the bottom surface of the connection part 8131 may be inclined toward the outside, and the first inclined portion G11 of the second guide surface S8212 may be inclined to overlap and correspond to the bottom surface of the connection part 8131 in the vertical direction.

More specifically, the inclination direction of the f the connection part 8131 and the inclination direction of first inclination portion G11 of the second guide surface S8212 may be inclined toward the outer lower side in the same manner as each other. In this case, the inclination of the connection part 8131 and the first inclined portion G11 may have the same value within a range of approximately 10%.

Due to the inclination direction of the connection part 8131 and the first inclined portion G11, a passage through which the outermost formulation T11 moves between the connection part 8131 and the first inclined portion G11 when the rotor 803 rotates forward may be provided.

For the smooth movement of the outermost formulation T11 in the corresponding passage, the shortest distance between the connection part 8131 and the first inclined portion G11 may be greater than one time and less than 2 times of at least one of the width W10 or the length L10 of the formulation T10.

As described above, when the assembly of the discharge unit 80 is completed, the cartridge 70 and the discharge unit 80 may be coupled to each other through screw coupling using a screw thread 721 of the coupling part 72 of the cartridge 70 in which the formulation 20 is accommodated and a screw thread 8111 of the housing body 811 to complete the assembly of the formulation cartridge assembly 60.

Here, since the cartridge 70 is assembled with a stopper blocking an inlet removed, the plurality of formulations T10 stored in the cartridge 70 may be introduced toward the discharge unit 80 disposed at the lower portion through the opened inlet, and thus, as the rotor 803 rotates, the formulations T10 may be discharged to the outside one by one.

As a result, the plurality of formulations T10 discharged from the cartridge 70 may be disposed in the inner space of the insertion restriction part 813 of which the lower portion is blocked by the discharge cap 802 and the rotor 803, and the outermost formulation T11 and the inner formulation T12, which are arranged in a line, may also be disposed in each formulation guide hole 834 disposed in the rotor 803.

In order to discharge the formulation, when the rotor 803 rotates forward by the operation of the control unit, the formulation T10 may move outward in the internal space of the insertion restriction part 813 by centrifugal force, and thus, the outermost formulation T11 and the inner formulation T12 may be continuously disposed in the formulation guide holes 834, respectively.

In this embodiment, a rotation speed of the rotor 803 may be 50 rpm to 150 rpm.

If the rotation speed of the rotor 803 is 50 rpm or more, the discharge speed of the formulation T10 may be stably maintained at the set speed so that the movement and discharge of the formulation T10 is smooth, and when the rotation speed of the rotor 803 is 150 rpm or less, the formulation T10 may be prevented from being damaged due to an excessive speed of the rotor 803, and thus, the formulation T10 may be smoothly discharged to the discharge hole H8212.

At least one of the width W10 or length L10 of the formulation T11 disposed on the second guide surface S8212 may be greater than a distance between the top surface of the second guide surface S8212 and the top surface of the second rotor rail 833, and thus, the corresponding formulation T11 may protrude upward from the top surface of the second rotor rail 833. As a result, when the rotor 803 rotates forward, the formulation T11 may be pushed in the corresponding direction by the rotor 803 rotating forward, and thus, the formulation T11 may smoothly rotate in the forward direction.

The outermost formulation T11 and the inner formulation T12 may rotate and move in a circular manner along the second guide surface S8212 and the first guide surface S8211 of the discharge cap 802, respectively.

When the outermost formulation T11 moves along the second guide surface 8212, a space defined by the first inclined portion G11 of the second guide surface 8212 and the connection part 8131 of the upper housing body 811 may be referred to as a first movement passage, and a space defined by the second inclined portion G12 of the second guide surface 8212 and the second portion 8152 that is the inclined surface of the formulation guide protrusion 815 may be referred to as a second movement passage.

As illustrated in FIG. 12a, when the formulation guide hole 834 of the rotor 803 does not overlap the discharge hole H8212 and is disposed on the first and second guide surfaces S8211 and S8212 of the discharge cap 802, the inner formulation T12 disposed in the formulation guide hole 834 may move outward by the centrifugal force caused by the rotation of the rotor 803 to move to the first movement passage to become the outermost formulation T11, thereby forming the outermost formulation T11.

As illustrated in FIGS. 12a to 12d, the insertion restriction part 813 may be disposed adjacent to the boundary line between the first rotor rail 832 and the second rotor rail 833, but a distance between the lower end of the insertion restriction part 813 and the top surface of the first rotor rail 832 may be less than the width or height of the formulation. Thus, as illustrated in FIG. 12a, the formulation the first rotor rail 832 may be trapped in the internal space by the insertion restriction part 813, and thus, the formulation may not move to the first connection passage, which is a space defined by the connection part 8131 of the housing and the second guide surface S8212 of the discharge cap without passing through the formulation guide hole 834.

In addition, as illustrated in FIG. 12b, the formulation guide protrusions 815 may be disposed outside the first rotor rail 832 adjacent to the discharge hole H8212, but the lower end of a portion of the formulation guide protrusions 815 may be disposed lower than the top surface of the first rotor rail 832.

In addition, a distance Dt between the lower end of the portion of the formulation guide protrusion 815, which is in contact with the discharge hole H8212, and the first guide surface may be less than the width or height of each of the formulations T11 and T12.

Thus, as illustrated in FIG. 12c, when the formulation guide hole 834 is disposed in the discharge hole H8212, the outermost formulation T11 disposed in the space between the connection part 8131 of the housing and the second guide surface S8212 of the discharge cap may drop into the discharge hole H8212, but may not drop into the discharge hole H8212 because the inner formulation T12 is blocked by the formulation guide protrusion 815 disposed at the upper portion.

Additionally, the formulation guide protrusion 815 may be disposed to overlap the second rotor rail 833, and at this time, a gap between the top surface of the second rotor rail 833 and the bottom surface of the formulation guide protrusion 815 may be less than the width W10 or length L10 of the formulation T12. Thus, the formulation 13 disposed on the first rotor rail 832 may be blocked by the formulation guide protrusion 815 and thus do not move to the second rotor rail 833.

In addition, as illustrated in FIG. 12d, when the formulation guide hole H8212 may overlap the discharge hole H8212 to perform the dropping of the outermost formulation T11, the inner formulation T12 may drop into the discharge hole H8212 by being blocked by the formulation guide protrusion 815.

Since the outward movement of the formulation T13 disposed on the first rotor rail 832 of the rotor 803 is blocked by the inner surface of the housing body 811, the formulation T13 may be prevented from being introduced into the first connection passage.

Next, with reference to FIGS. 13 to 17, a process of discharging the formulation T10 will be described.

FIGS. 13 to 17 are views for explaining a process of discharging formulation through the discharge unit according to an embodiment of the present invention.

FIGS. 13 to 17, (a) is a view when the discharge cap 802 is viewed from the top and illustrates a position of the formulation guide hole 834 and a virtual position of the formulation guide protrusion 815, and (b) is a cross-sectional view of the housing 801, the rotor 803, and the discharge cap 802 along the first movement passage through which the formulation moves. Specifically, in (b), a space defined by the first inclined portion G11 of the second guide surface 8212 and the connection part 8131 of the upper housing body 811 may be referred to as a first movement passage, and a space defined by the second rotor rail 833, the second inclined portion G12 of the second guide surface 8212, and the second portion 8152 that is the inclined surface of the formulation guide protrusion 815 may be referred to as a second movement passage.

As illustrated in (a) and (b) of FIG. 13, when the rotor 803 rotates forward in a state in which the outermost formulation T11 and the inner formulation T12 are disposed in a line in the formulation guide hole 834, the inner formulation T12 may move along the first guide surface S8211, and the outermost formulation T11 may move along the first movement passage formed by the second guide surface S8212 and the connection part 8131.

Here, since no physical structure exists between the outermost formulation T11 and the inner formulation T12 arranged in a line, the outermost formulation T11 and the inner formulation T12 may have a contact state.

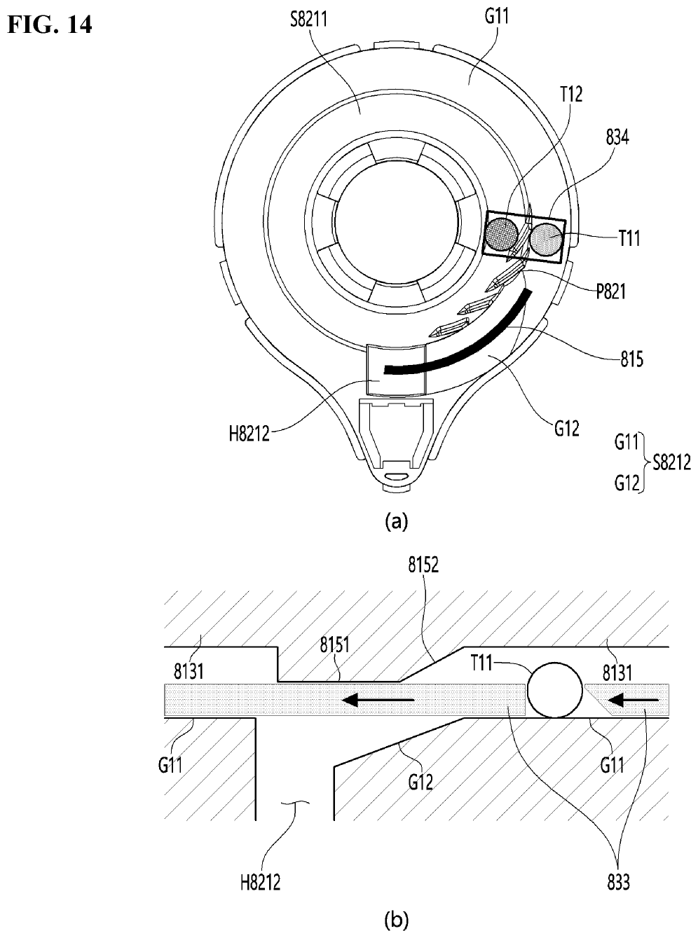

Thereafter, as illustrated in (a) of FIG. 14, when the rotor 803 continues to rotate forward, the formulation guide hole 834 of the corresponding order among the plurality of formulation guide holes 834 may meet the plurality of discharge guide protrusions P821 of the discharge cap 802 to sequentially pass through the discharge guide protrusions P821 arranged in a line.

Thus, the plurality of discharge guide protrusions P821 may be sequentially disposed between the inner formulation T12 and the outermost formulation T11 to physically separate the two formulations 12 and 11 in the formulation guide hole 834.

As a result, the inner formulation T12 may move toward the inside of the discharge cap 802, i.e., toward the rotor insertion hole H8211 with the discharge guide protrusion P821 therebetween, and the outermost formulation T11 may be separated to toward the outside i.e., the outside of the insertion restriction part 813.

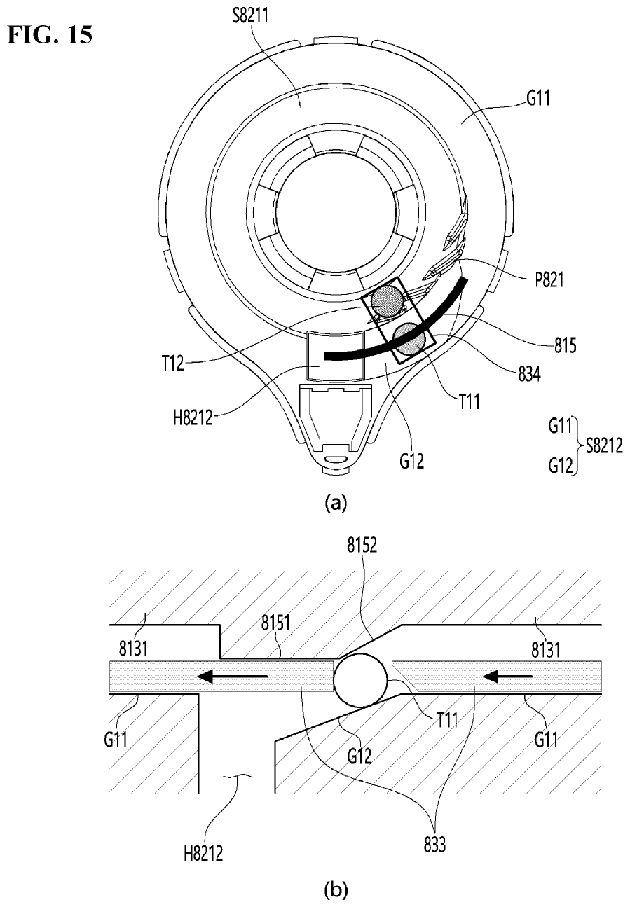

Thus, as illustrated in (a) of FIG. 15, the formulation guide hole 834 may pass through the lower portion of the formulation guide protrusion 815 by the continued forward rotation of the rotor 803, and the outermost formulation T11 and the inner formulation T12 may be spaced completely spatially separated by the formulation guide protrusion 815.

Here, the inner formulation T12 may be supported on the inside by the formulation guide protrusion 815 to continuously move along the first guide surface S8211, and the outermost formulation T11 may move along a lower end of the formulation guide protrusion 815.

More specifically, as illustrated in (b) of FIG. 15, the outermost formulation T11 may forcibly move in an oblique direction toward the discharge hole H8212 along the second movement passage defined by the second inclined portion G12 of the second guide surface S8212 and the second portion 8152 that is the lower inclined surface of the formulation guide protrusion 815.

As the outermost formulation T11 descends in the oblique direction along the second movement passage, a partial empty space may be formed in the formulation guide hole 834 disposed in the outermost formulation T11, and the inner formulation (T12) may be pushed outward due to the centrifugal force caused by the rotation of the rotor unit 803, but the formulation guide protrusion 815 of the present invention may prevent the inner formulation T12 from being pushed outward of the formulation guide hole 834.

Thus, even if the outermost formulation T11 descends in the oblique direction along the second movement passage, the inner formulation T12 may be continuously disposed inside the formulation guide hole 834 [that is, the upper portion of the first guide surface S811].

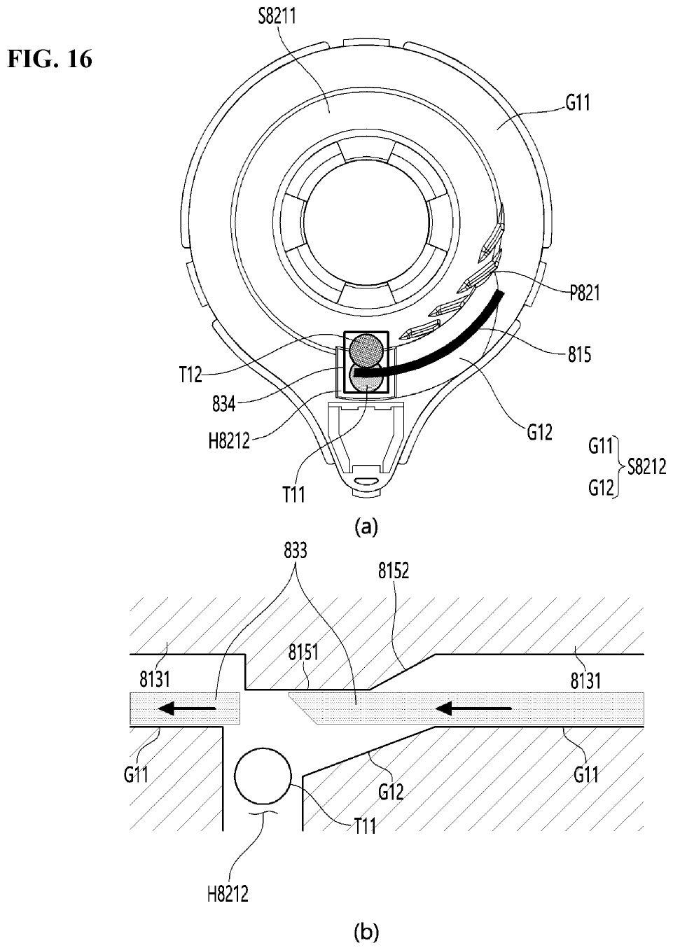

Thus, as illustrated in (a) and (b) of FIG. 16, when the formulation guide hole 834 overlaps the discharge hole H8212 of the discharge cap 802 through the continued forward rotation of the rotor 803, the outermost formulation T11 may move into the discharge hole H8212 and then be discharged to the outside along the discharge tube 823. Here, the outermost formulation T11 to be discharged may naturally move downward along the discharge tube 823 while colliding with an inner wall of at least one of the discharge hole H8212 or the discharge tube 823 in the oblique direction.

As described above, the second movement passage may allow the outermost formulation T11 to enter the discharge tube 823 in the oblique direction, and thus, even if the rotor 803 rotates at a relatively high speed, a phenomenon (Jam) in which the plurality of formulations T10 blocks the discharge port H8212 may be prevented from occurring.

When the outermost formulation T11 drops into the discharge hole H8212, the inner formulation T12 disposed on the first guide surface S8211 in the formulation guide hole 834 may be, as illustrated in (a) of FIG. 16, prevented from moving toward the discharge hole H8212 by the formulation guide protrusion 815, and thus, the inner formulation T12 may not drop into the discharge hole H8212 and also may not be discharged to the outside.

In order to prevent the discharge of the inner formulation T12, a vertical distance Dt (FIG. 12D) between the formulation guide protrusion 815 (specifically, the bottom surface of the formulation guide protrusion 815) and the top surface of the first guide surface S8211, as previously described, may be less than the width W10 or length L10 of the formulation T10.

As a result, whenever each formulation guide hole 834 overlaps the discharge hole H8212, only one formulation (i.e., the outermost formulation) 11 may normally drop into the discharge hole H8212 and be discharged to the outside.

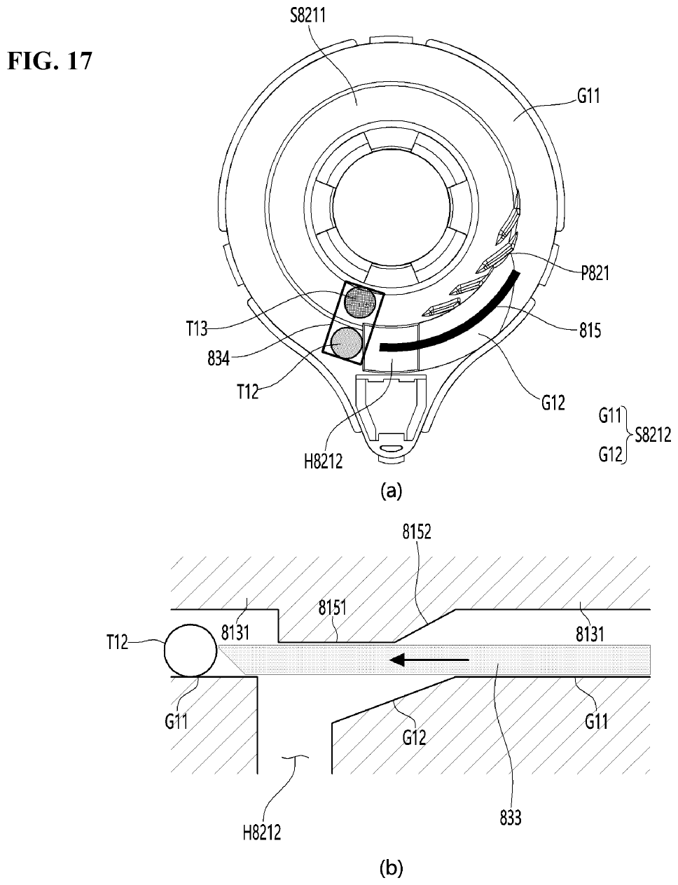

Thereafter, after the outermost formulation T11 drops, due to the forward rotation of the rotor 803, as illustrated in (a) and (b) of FIG. 17, the formulation guide hole 834 may pass through the discharge hole H8212. Here, the inner formulation T12 may be pushed outward of the formulation guide hole 834 by the centrifugal force at a point at which the rotor 803 passes the end E815 of the formulation guide protrusion 815 and may be disposed in the first movement passage, and thus, another formulation T13 disposed near the guide hole 834 may be introduced into the corresponding formulation guide hole 834.

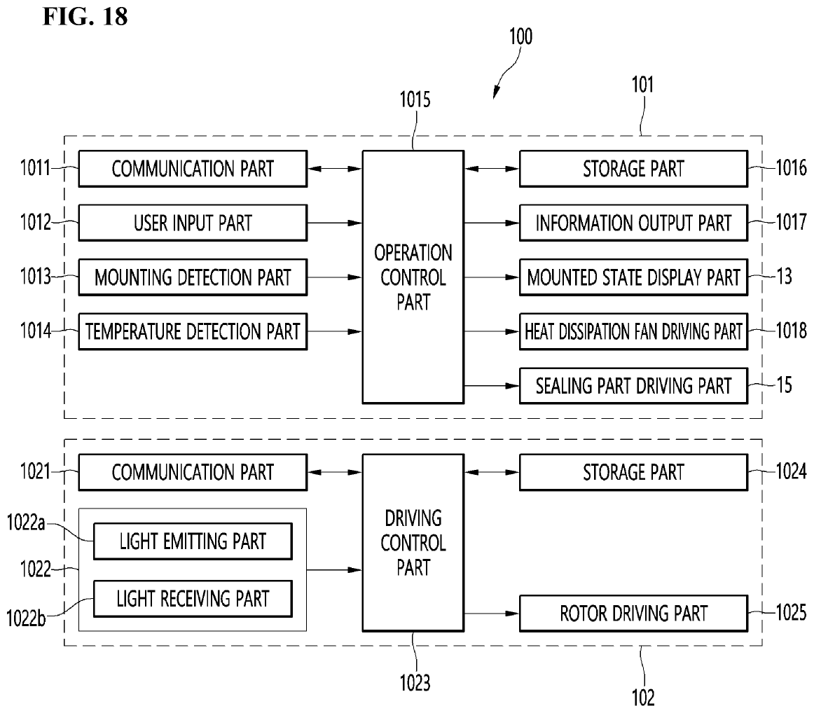

Next, with reference to FIG. 18, the control unit for controlling the operation of the formulation dispenser 1 of this embodiment will be described.

As illustrated in FIG. 18, the control unit 100 may include a terminal control unit 101 disposed in the device terminal 30 and a formulation cartridge control unit 102 disposed in each formulation cartridge assembly 60. The terminal control unit 101 and the formulation cartridge control unit 102 may communicate with each other to transmit and receive necessary information.

The terminal control unit 101 may include a communication part 1011, a user input part 1012, a mounting detection part 1013, a temperature detection part 1014, an operation control part 1015 connected thereto 1011 to 1014, a storage part 1016 connected to the operation control part 1015, an information output part 1017 connected to the operation control part 1015, a mounted state display part 13 connected to the operation control part 1015, a heat dissipation fan driving part 1018 connected to the operation control part 1015, and a sealing part driving part 15 connected to the operation control part 1015.

In addition, the formulation cartridge control unit 102 may include a communication part 1021, a discharge number detection part 1022, a driving control part 1023 connected to the communication part 1021 and the discharge number detection part 1022, a storage part 1024 connected to the driving control part 1023, and a rotor driving part 1025 connected to the driving control part 1023.

In the terminal control unit 101, the communication part 1011 may be configured to communicate between the formulation cartridge control unit 102 and communication with an external device such as a server and may include a wired or wireless communication module.

The communication part 1011 may include, for example, at least one of a short-range wireless communication module such as Wi-Fi or ZigBee and an Internet communication module.

The user input part 1012 may be configured to input data or commands necessary for the operation of the formulation dispenser 1 and may be a touch panel or an operation switch.

Information input to the terminal control unit 101 through the user input part 1012 may include at least one of the user's current health condition (e.g., information related to physical and mental conditions) or user's body-related information (e.g., age, gender, medical history, and occupation).

As already described, the mounting detection part 1013 may detect a state of each cartridge accommodation hole H12 and then detect whether the formulation cartridge assembly 60 is normally mounted in the corresponding cartridge accommodation hole H12 to output a mounted state signal having the corresponding state.

Thus, the operation control part 1015 may control an operation of the mounted state display part 13 according to a state of each accommodation hole H12 determined according to the signal applied to the mounting detection part 1013.

The temperature sensor 1014 may detect a temperature inside the accommodation part 12 or the inside of the housing 11 to control a rotation speed of the heat dissipation fan and output a temperature detection signal of the corresponding state to the operation control part 1015.

Thus, the operation control part 1015 may control an operation of the heat dissipation fan driving part 1018 to control whether the heat dissipation fan rotates and the rotation speed of the heat dissipation fan.

The operation control part 1015 may be a processor as a control module that controls an overall operation of the formulation dispenser 1 using the input or transmitted signals.

For example, the operation control part 1015 may determine the type and number of formulations T10 to be discharged from the formulation dispenser 1 using a signal transmitted from the server through the communication part 1011 to transmit the determined results to the formulation cartridge control unit 102.

As a result, the formulation cartridge control unit 102 may control the operation of the formulation cartridge assembly 60 in which the determined type of formulation T10 is stored among the plurality of formulation cartridge assemblies 60 to discharge the determined number of formulations T10.

The accommodation part 1016 may store data necessary for the operation of the terminal control unit 101, a driving program, data generated during the operation, and the like. This accommodation part 1016 may be a memory.

The information output part 1017 may output visual information under the control of the operation control part 1015 and may be a flat panel display panel such as a liquid crystal display panel or an organic light emitting display panel. The information output part 1017 may be a display panel including a touch panel.

Since the user checks the information of the user currently using the formulation dispenser 1, the type and number of discharged formulations T10, etc. using the information output through the information output part 1017, the precise dosage of the formulation T10 may be provided to the user.

In addition, the information output part 1017 may display information of each user the currently using formulation dispenser 1 (e.g. name and user image (e.g. Photo)), the current situation of each formulation cartridge assembly 60, for example, the type and remaining amount (%) of formulation T10 contained in each formulation cartridge assembly 60, a selection screen of the current user's physical condition (e.g., fatigue, stomatitis, allergic rhinitis, excessive drinking, overtime work, after exercise, e.g.) for discharging the formulations, and results of nutritional components combined after determining the body condition.

As already described, the mounted state display part 13 may display whether the formulation cartridge assembly 60 is mounted in each accommodation hole H12 because the operation state is changed according to the signal output from the mounting detection part 1013.

The mounted state display part 13 may include plurality of light emitting parts such as light emitting diodes that output light having different colors (e.g., a first color and a second color).

Thus, when the formulation cartridge assembly 60 is normally mounted in the corresponding accommodation hole H12, the light emitting part having the first color may be turned on, whereas when the formulation cartridge assembly 60 is not normally mounted in the corresponding accommodation hole H12 or is empty, the light emitting part having the second color may be turned on.

The number of light emitting parts having the first color and the number of light emitting parts having the second color may be provided as much as the number of accommodation holes H12.

The heat dissipation fan driving part 1018 may be configured to drive the heat dissipation fan, and the sealing part driving part 15 may be configured to drive the sealing part 14, and thus, each of the heat dissipation fan driving part 1018 and the sealing part driving part 15 may include a motor and a motor driving circuit for driving the corresponding motor.

Thus, the operation control part 1015 may output a control signal of the corresponding state to the heat dissipation fan driving part 1018 according to the temperature determined according to the temperature detection signal applied from the temperature sensor 1014 to control whether the heat dissipation fan rotates and the rotation state.

In addition, when the operation control part 1015 starts the operation of the formulation dispenser 1 for discharging the formulation suitable for the user using an operation start signal applied through the user input part 1012, the control signal of the corresponding state may be output to the sealing part driving part 15 to allow the sealing part 14 to descend so that the formulation T10 is discharged from the formulation dispenser 1.

On the other hand, when it is determined that the discharge operation of the corresponding formulation T10 is completed, the operation control part 1015 may output the control signal of the corresponding state to the sealing part driving part 15 to allow the sealing part 14 to ascend so as to block the opened formulation dispenser 1, thereby protecting the formulation cartridge assembly 60 from the external foreign substances.

Here, the operation control part 1015 may determine an operation end signal applied from the user input part 1012 or the operation state of each formulation cartridge assembly 60 to determine whether the discharge operation of the formulation T10 suitable for the user is completed.

Next, the formulation cartridge control unit 102 will be described.

The communication part 1021 of the formulation cartridge control unit 102 may also communicate with the terminal control unit 101 and may also be configured to communicate with an external device such as a server, and thus, the communication part 1021 may include at least one of a short-range wireless communication module or an Internet communication module.

The discharge number detection part 1022 may be configured to count the number of formulations T10 discharged through the discharge hole H8212 and may output a discharge number detection signal in the corresponding state according to whether the formulation is discharged through the discharge hole H8212 to output the signal to the driving control part.

For example, the discharge number detection part 1022 may use an optical sensor including a light emitting part 1022a and a light receiving part 1022b such as a light emitting diode and a light receiving transistor.

Thus, the driving control part 1023 may determine the number of currently discharged formulations T10 using the discharge number detection signal applied from the light receiving part 1022b of the discharge number detection part 1022.

The driving control part 1023 may also be a processor as a control module for controlling the overall operation of the formulation cartridge control unit 102.

The storage part 8821 may be a storage medium such as a memory that stores information related to the formulation cartridge assembly 60.

As already described, the storage part 8821 mounted in each formulation cartridge assembly 60 may store at least one of the type, initial number, the number for formulation T10 currently discharged to the outside, and an expiration date and expiration date of the formulation cartridge assembly 60.

The rotor driving part 1025 may be configured to control the rotational operation of the rotor 803 and may also include a motor and a motor driving circuit for driving the motor.

Thus, since the driving shaft part 835 of the rotor 803 is connected to the driving shaft of the motor, the rotor driving part 1025 may operate according to the control of the driving control part 1023 to allow the rotor 803 connected to the motor to rotate in the forward or reverse direction.

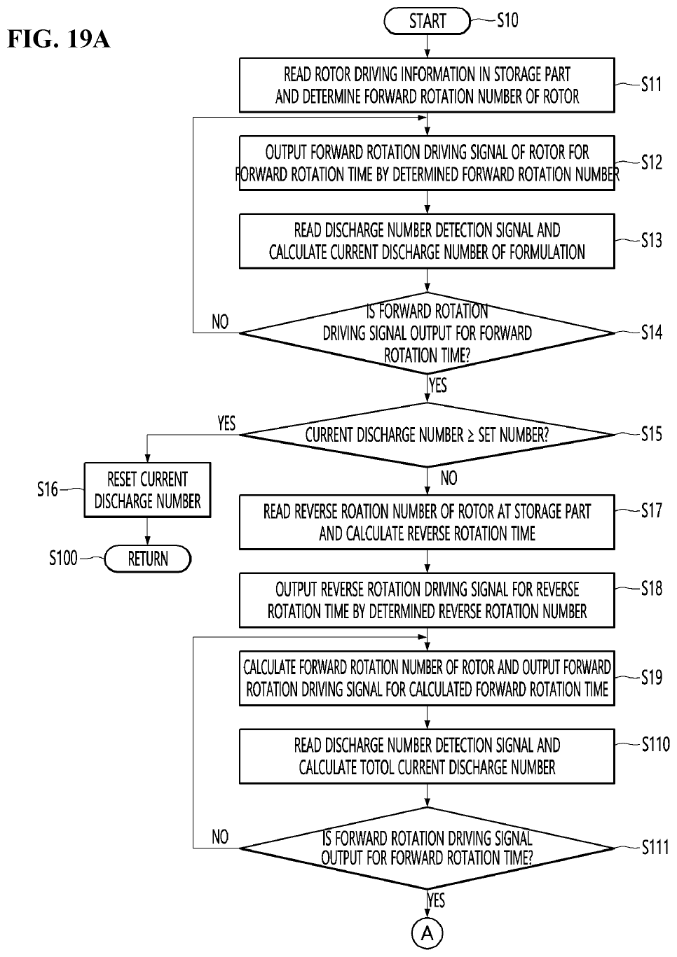

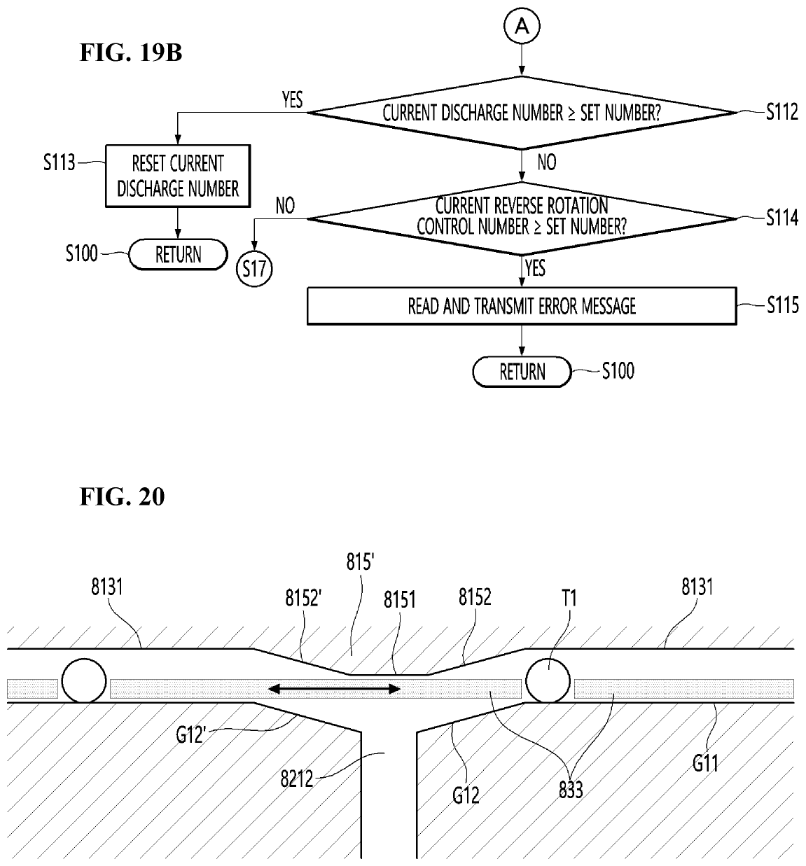

Next, with reference to FIGS. 19a and 19b, the formulation discharge operation of the formulation cartridge control unit 102 having this structure will be described.

First, when necessary power for operation of the formulation cartridge control unit 102 is supplied, and the operation of the formulation cartridge control unit 102 starts, the driving control part 1023 may also start the operation (S10).

Thus, the driving control part 1023 may read rotor driving information from the storage part 1024 to determine the number of normal rotations of the rotor 803 (S11).

In this embodiment, the rotor drive information may be determined according to the user who is currently using the information, for example, may provide the type of formulation T10 to be taken according to the user's current health condition and the dosage of the corresponding type (i.e., the number of discharges).

Thus, when the formulation T10 stored in the formulation cartridge assembly 60 of which oneself is being belong to the currently dispensed formulation T10, the driving control part 1023 may calculate the number of forward rotation of the rotor 803 according to according to the dosage of the corresponding type.

In this embodiment, since three formulations T10 are discharged during one forward rotation, the driving control part 1023 may calculate the number of forward rotation of the rotor 803 according to the dosage.

When the forward rotation number of the corresponding rotor 803 is determined, the driving control part 1023 may output the a forward rotation driving signal to the rotor driving part 1025 for a forward rotation time (e.g., the first forward rotation time) corresponding to the determined forward rotation number (S12) to allow the rotor 803 to rotate forward so that the corresponding formulation T10 is discharged.

In this embodiment, since the rotation speed of the rotor 803 is already fixed, if the number of forward rotations or reverse rotations is determined, the corresponding reverse rotation time and forward rotation time may also be easily calculated.

As described above, when the forward rotation of the rotor 803 starts, the driving control part 1023 may read the discharge number detection signal applied from the discharge number detection part 1022 to calculate the current number of discharges having the corresponding type of formulation T10 and then store the calculated value in the storage part 1024 (S13).

The operation of calculating the current number of discharges may be continued while the forward rotation operation of the rotor 803 is performed.

Next, when the output of the forward rotation drive signal is completed for a time corresponding to the determined forward rotation number (S14), the operation control part 1015 may determine whether the current number of discharged formulations stored in the storage part 1024, i.e., the total number of formulations T10 of the corresponding type discharged during the corresponding time is equal to a set number (S15). Here, the set number may be determined according to the dosage of the corresponding type of formulation T10 and stored in the storage part 1024.

When the current number of discharged formulations is equal to the set number (S15), the driving control part 1023 may determine that the formulation T10 of the corresponding type is normally discharged in a predetermined dosage. Thus, the driving control part 1023 may reset the current discharge number to ‘0’ (S16) and then proceed to a return process (S100).

However, if the current number of discharged formulations does not reach the set number (S15), that is, if the formulation T10 of the corresponding type is not discharged as much as the predetermined dosage, the driving control part 1023 may determine that the discharge hole H8212 is blocked, or the formulation is not smoothly discharged due to the plurality of formulations T10 overlapping each other.

Thus, the driving control part 1023 may reversely rotate the rotor 803 for a predetermined time and then perform the forward rotation operation again so that the insufficient number of formulations is discharged.

For this, the driving control part 1023 may read the number of reverse rotations of the rotor 803 using the data stored in the storage part 1024 to calculate the reverse rotation time of the rotor 803 (S17). In the case of this embodiment, the number of reverse rotations for one reverse rotation control may be already determined.

In this embodiment, the reverse rotation time for one-time reverse rotation control is calculated using the number of reverse rotations, but, on the other hand, in an alternative example, the reverse rotation time for one-time reverse rotation control may be directly stored in the storage part 1024.

Then, in order to perform reverse rotation of the rotor 803 during the reverse rotation time for the corresponding reverse rotation control, the driving control part 1023 may output a control signal in a state corresponding to the rotor driving part 1025 for reverse rotation (S18). Here, the driving control part 1023 may increase in number of times of the reverse rotation control (initial value=0) by ‘1’ to store the increasing times of reverse rotation control in the storage part 1024 (S18).

Thus, the rotor 803 may perform a reverse rotation operation for a reverse rotation time determined by the control of the rotor driving part 1025.

During the reverse rotation of the rotor 803, the formulation guide hole 834 in which the outermost formulation T11 exists may exist at least one of the plurality of formulation guide holes 834, and the outermost formulation T11 may not drop into the discharge hole H8212 even though the formulation guide hole 834 overlaps the discharge hole H8212.

That is, the outermost formulation T11 existing in the formulation guide hole 834 may protrude to a top surface of the second rotor rail 833 surrounding the formulation guide hole 834.

Thus, the formulation guide hole 834 may block a portion of the discharge hole H8212 overlapping a portion of the discharge hole H8212, and the protruding portion of the outermost formulation T11 may collide with the start end E815 of the formulation guide protrusion 815 to interfere with the normal reverse rotation operation. Thus, when the outermost formulation T11 is in contact with the start end S815 of the formulation guide protrusion 815, the rotor 803 may not perform the reverse rotation operation any more.

Due to the stop of the reverse rotation of the rotor 803, the discharge hole H8212 may not be opened to the extent that the outermost formulation T11 is discharged, and thus, even though the reverse rotation drive signal is output to the rotor driving part 1025, the discharge of the outermost formulation T11 and the actual reverse rotation of the rotor unit 803 may be temporarily stopped.

As a result, when the rotor 803 rotates reversely, the outermost formulation T11 may not be discharged, and only during forward rotation, the outermost formulation T11 may be normally discharged.

As described above, after the reverse rotation drive signal is output for a predetermined reverse rotation time, the driving control part 1023 may determine the number of forward rotations of the rotor 803 again to calculate the forward rotation time (e.g., the second forward rotation time) and then output the forward rotation driving signal to the rotor driving part 1025 during the calculated forward rotation time.

Here, the number of normal rotations of the rotor 803 may be determined by the number calculated by subtracting the current number of discharged formulations from the set number, that is, the number of formulations to be additionally discharged. Thus, the second normal rotation time may be less than the first normal rotation time.

In operation S19, after outputting the forward rotation driving signal for the additional discharge of the insufficient formulation to the rotor driving part 1025, the driving control part 1023 may read the discharge number detection signal applied from the discharge number detection part 1022 to additionally determine whether the outermost dosage form T11 has been discharged, and thus, the current total number of discharged formulations may be calculated and stored in the storage part 1024 (S110). Here, the current total number of discharged formulations may be the total number of corresponding formulations T10 discharged during the total normal rotation time (e.g., first normal rotation time+second normal rotation time) after the discharge operation of the formulation starts.

Next, after the forward rotation of the rotor 803 is performed for in a predetermined forward rotation time operation S19 (S111), the driving control part 1023 may determine that the current total number of discharged formulations stored in the storage part 1024 reaches the set number (S112).

If the current total number of discharged formulations is equal to the set number (S112), the driving control part 1023 may determine that the corresponding type of formulation T10 has been normally discharged by the predetermined dosage to reset the current number of discharged formulations to ‘0’ (S113) and then proceed to a return process (S100).

However, if the current total number of discharged formulations does not reach the set number (S112), that is, if the insufficient number of formulations is not normally discharged, the driving control part 1023 may determine that the current reverse rotation control number reaches the set number (S114).

Since the current reverse rotation control number may be the total number of times that the reverse rotation driving signal is output after the first forward rotation driving signal is output, the driving control part 1023 may increase in number of current reverse rotation control by ‘1’ whenever the reverse rotation control is ended.

Thus, if the current number of reverse rotation control does not reach the set number (S114), the driving control part 1023 may proceed to the operation S17 to control the reverse rotation control of the rotor 803 for the next (e.g., second) reverse rotation control number.

However, when the current reverse rotation control number reaches the set number (S114), the driving control part 1023 may determine that the current formulation cartridge assembly 60 is not normally discharged due to the blocking or the like.

Thus, the driving control part 1023 may read an error message stored in the storage part 1024 to transmit the message to the terminal unit control 101 through the communication part 1021, thereby outputting the result (S115).

Thus, the operation control part 1015 of the terminal control unit 101 may receive the error message of the formulation cartridge control unit 102 transmitted through the communication part 1011 and then output the error message to the information output part 1017.

Thus, since the user recognizes a state in which the formulation cartridge assembly 60 is not normally discharged using the error message output to the information output part 1017, the state of the corresponding formulation cartridge assembly 60 may be checked to perform cleaning of the discharge hole H8212.

In an alternative example, the formulation cartridge control unit 102 may have a separate information output part connected to the driving control part 1023, and in this case, the driving control part 1023 may directly output the error message to the information output part.

For this reason, when the dosage amount of formulation T10 of the corresponding type is not discharged, the driving control part 1023 may repeat the reverse rotation operation and the forward rotation operation of the rotor 803 by a predetermined number of times to additionally discharge the corresponding formulation T10.

FIG. 20 is a view for explaining another example of the discharge unit according to the present invention.

In FIG. 20, descriptions of the same parts as those described above will be omitted and other parts will be mainly described.

As illustrated in FIGS. 13 to 17, the case in which the second inclined portion G12 of the second guide surface 8212 and the second portion 8152, which is the inclined surface of the formulation guide protrusion 815 in the discharge unit, are disposed at one side of the discharge hole H8212 has been described. However, the present invention is not limited thereto.

As illustrated in FIG. 20, a discharge unit according to the present invention may include second inclined portions G12 and G12′ of a second guide surface 8212 and second portions 8152 and 8152′, which are inclined surfaces of a formulation guide protrusion 815, at both sides of a discharge hole H8212.

Thus, a formulation may be discharged through the discharge hole H8212 regardless of a rotation direction of a rotor 803.

FIG. 20 illustrates a case in which an angle of inclination of each of the second inclined portions G12 and G12′ of the second guide surface 8212 and the second portions 8152 and 8152′, which are the inclined surfaces of the formulation guide protrusion 815, are constant, as an example. However, the present invention is not limited thereto.

For example, unlike illustrated in FIG. 20, the angle of inclination of each of the second inclined portions G12 and G12′ and the second portions 8152 and 8152′ may increase as it approaches the discharge hole H8212. For this, each of the second inclined portions G12 and G12′ and the second portions 8152 and 8152′ may include a curved surface.

The technical features disclosed in each embodiment of the present invention are not limited to the corresponding embodiment, and unless incompatible with each other, the technical features disclosed in each embodiment may be merged and applied to other embodiments.

Therefore, in each embodiment, each technical feature is mainly described, but each technical feature may be merged and applied to each other unless incompatible with each other.

The present invention is not limited to the above-described embodiments and accompanying drawings, and various modifications and variations will be possible from the viewpoint of those skilled in the art to which the present invention belongs. Therefore, the scope of the present invention should be defined by not only the claims of this specification but also those equivalent to these claims.

1. A formulation cartridge assembly comprising:
a housing in which a formulation is disposed in an inner space thereof;
a discharge cap coupled and fixed to the housing and provided with a discharge hole, through which the formulation is discharged, in a portion of an edge thereof; and
a rotor rotatably disposed on the discharge cap and provided with a formulation guide hole in which the formulation to be discharged through the discharge hole is seated,
wherein the formulation guide hole extends outward from the inside of the rotor and has a width and length, which are defined by seating and arranging a plurality of formulations comprising a first formulation and a second formulation in a line in the formulation guide hole, and
as the rotor rotates, the plurality of formulations arranged in the formulation guide hole are sequentially discharged through the discharge hole.

2. The formulation cartridge assembly of claim 1, wherein the housing comprises:
a housing body configured to define an outer appearance of the housing and extend in a vertical direction;
an insertion restriction part disposed to be spaced apart from the housing body inside the housing body and extending in the vertical direction;
a connection part extending from a lower end of the insertion restriction part and connected to the housing body; and
a formulation guide protrusion which is provided to protrude downward from the connection part and of which a portion overlaps the discharge hole,
wherein, when the housing body is viewed from the top, an outer portion of the rotor is covered by the insertion restriction part.

3. The formulation cartridge assembly of claim 2, wherein the formulation guide protrusion increases in protruding length and cross-sectional width as the formulation guide protrusion approaches the discharge hole.

4. The formulation cartridge assembly of claim 2, wherein a lower end of the formulation guide protrusion comprises a first portion of which a protruding length is constantly maintained and a second portion of which a protruding length gradually increases toward the discharge hole,
wherein the first portion is disposed closer to the discharge hole than the second portion and vertically overlaps the discharge hole.

5. The formulation cartridge assembly of claim 2, wherein the discharge cap further comprises:
a rotor insertion hole of which a central portion is opened;
a flat first guide surface configured to surround the rotor insertion hole; and
a second guide surface connected to the first guide surface so as to surround the first guide surface, the second guide surface being inclined toward the outside,
wherein a portion of the rotor is inserted into the rotor insertion hole so as to rotatably coupled using the rotor insertion hole as a center.

6. The formulation cartridge assembly of claim 5, wherein the discharge hole is disposed in a portion of an edge of the discharge cap and disposed on an extension line of the second guide surface.

7. The formulation cartridge assembly of claim 5, wherein an interval between a lower end of a portion of the formulation guide protrusion, which overlaps the discharge hole, and the first guide surface is less than a width or height of the formulation.

8. The formulation cartridge assembly of claim 5, wherein the insertion restriction part is adjacent to a boundary surface between the first guide surface and the second guide surface in the vertical direction.

9. The formulation cartridge assembly of claim 5, wherein the second guide surface comprises a first inclined portion that is inclined toward the outside of the second guide surface and a second inclined portion that is inclined toward the discharge hole.

10. The formulation cartridge assembly of claim 9, wherein the second inclined portion of the second guide surface and the portion of which the protruding length increases from the formulation guide protrusion overlap each other in the vertical direction and are inclined to correspond to each other.

11. The formulation cartridge assembly of claim 9, wherein a bottom surface of the connection part is inclined toward the outside, and
the first inclined portion of the second guide surface and the bottom surface of the connection part overlap each other in the vertical direction and are inclined to correspond to each other.

12. The formulation cartridge assembly of claim 5, wherein the rotor comprises:
a rotor cone;
a first rotor rail connected to the rotor cone, disposed along the outside of the rotor cone, and disposed to overlap the first guide surface;
a second rotor rail connected to the first rotor rail, disposed along the outside of the first rotor rail, and disposed to overlap the second guide surface; and
a driving shaft part disposed on a rear surface of the rotor cone and inserted into the rotor insertion hole,
wherein each of the first rotor rail and the second rotor rail is divided into a plurality of portions by the formulation guide hole.

13. The formulation cartridge assembly of claim 12, wherein a stepped portion is provided between the first rotor rail and the second rotor rail, and a top surface of the second rotor rail is disposed to be spaced downward from a top surface of the first rotor rail.

14. The formulation cartridge assembly of claim 12, wherein the insertion restriction part is disposed adjacent to a boundary line between the first rotor rail and the second rotor rail,
wherein an interval between a lower end of the insertion restriction part and a top surface of the first rotor rail is less than a width or height of the formulation.

15. The formulation cartridge assembly of claim 12, wherein the formulation guide protrusion is adjacent to the discharge hole and disposed outside the first rotor rail,
wherein a lower end of a portion of the formulation guide protrusion is disposed lower than a top surface of the first rotor rail.

16. The formulation cartridge assembly of claim 1, further comprising a cartridge configured to accommodate the formulation therein and coupled to the housing so that the formulation is introduced into the inner space of the housing.

17. A formulation dispenser comprising:
a plurality of formulation cartridge assemblies of any one of claims 1 to 16;
a plurality of motors connected to driving shaft parts of the plurality of formulation cartridge assemblies, respectively; and
a driving control part configured to control each of the plurality of motors.

18. The formulation dispenser of claim 17, further comprising a discharge number detection part configured to detect the number of formulations discharged through the discharge hole of each of the plurality of formulation cartridge assemblies,
wherein the discharge number detection part is disposed below the discharge hole of each of the plurality of formulation cartridge assemblies and connected to the driving control part.
